(19) United States
(12) Patent Application Publication
(10) Pub. No.: US 2024/0056204 A1
(43) Pub. Date: Feb. 15, 2024

(54) SUB-BAND INTERFERENCE CANCELLATION TECHNIQUES FOR NETWORK ENERGY SAVINGS

(71) Applicant: QUALCOMM Incorporated, San Diego, CA (US)

(72) Inventors: Konstantinos DIMOU, New York, NY (US); Igor GUTMAN, Hod HaSharon (IL); Junyi LI, Fairless Hills, PA (US)

(21) Appl. No.: 18/339,926

(22) Filed: Jun. 22, 2023

Related U.S. Application Data
(60) Provisional application No. 63/396,800, filed on Aug. 10, 2022.

(51) Int. Cl. H04B 17/336; H04W 24/10; H04W 74/08

(52) U.S. Cl. CPC H04B 17/336; H04W 24/10; H04W 74/0816

(57) ABSTRACT

Methods, systems, and devices for wireless communications are described that provide for an originating network entity to request sub-band interference cancellation (SBIC) information from one or more neighboring network entities for downlink communications via one or more sub-bands. The neighboring network entities may serve at least one user equipment (UE) using adjacent sub-bands to the one or more sub-bands of the originating network entity. The originating network entity may exchange information related to sub-bands of interest to the one or more neighboring network entities, and whether SBIC is to be activated or is not to be activated for only the identified sub-bands versus across all operating sub-bands. The one or more neighboring network entities may configure measurement reporting by the UE for multiple time periods, corresponding to when transmissions are present and absent from the allocated sub-band(s) of the originating network entity.

### CROSS REFERENCE

The present application for patent claims the benefit of U.S. Provisional Patent Application No. 63/396,800 by DIMOU et al., entitled “SUB-BAND INTERFERENCE CANCELLATION TECHNIQUES FOR NETWORK ENERGY SAVINGS,” filed Aug. 10, 2022, assigned to the assignee hereof, and expressly incorporated by reference herein.

### FIELD OF TECHNOLOGY

The following relates to wireless communications, including sub-band interference cancellation techniques for network energy savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sub-band interference cancellation (SBIC) techniques for network energy savings. For example, the described techniques provide that an originating network entity may request SBIC information from one or more neighboring network entities for one or more sub-bands, where the neighboring network entities serve at least one user equipment (UE) using adjacent sub-bands. In some cases, the originating network entity may exchange information related to sub-bands of interest to the one or more neighboring network entities, and whether SBIC is to be activated or not for only the identified sub-bands (e.g., versus across all operating sub-bands). The one or more neighboring network entities may configure measurement reporting by the UE for multiple time periods, corresponding to when transmissions are present and absent from the allocated sub-band(s) of the originating network entity. The one or more UEs may report a difference in measured interference between the two time periods, or measured values for each time period. An originating network entity that serves the UE may receive the measurement report and determine whether SBIC for the allocated sub-band is to be activated or not, and may signal the determination to the originating network entity. In some cases, network entities may initiate the allocated-sub-band SBIC based on loading at each network entity being below a threshold level. Additionally, or alternatively, network entities may establish defined times at which the procedures are performed (e.g., based on a time of day when network loading is expected to be low).

A method for wireless communication at a user equipment (UE) is described. The method may include receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs, measuring the first subset of frequency bands during the first time period and the second time period, and transmitting, responsive to the measuring, an interference measurement report to the first network entity based on the measurement configuration and a difference in measurements of the first subset of frequency bands between the first time period and the second time period.

A UE for wireless communication is described. The UE may include a one or more memories storing processor-executable code, and one or more processors coupled with the one or more memories. The one or more processors individually or collectively operable to execute the code to cause the UE to receive a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs, measure the first subset of frequency bands during the first time period and the second time period, and transmit, responsive to the measuring, an interference measurement report to the first network entity based on the measurement configuration and a difference in measurements of the first subset of frequency bands between the first time period and the second time period.

Another UE for wireless communication is described. The UE may include means for receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs, means for measuring the first subset of frequency bands during the first time period and the second time period, and means for transmitting, responsive to the measuring, an interference measurement report to the first network entity based on the measurement configuration and a difference in measurements of the first subset of frequency bands between the first time period and the second time period.

A non-transitory computer-readable medium storing code for wireless communication at a UE is described. The code may include instructions executable by one or more processors to receive a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs, measure the first subset of frequency bands during the first time period and the second time period, and transmit, responsive to the measuring, an interference measurement report to the first network entity based on the measurement configuration and a difference in measurements of the first subset of frequency bands between the first time period and the second time period.

In some examples of the method, UEs, and non-transitory computer-readable medium described herein, the first time period corresponds to a first time duration in which the one or more other network entities refrain from transmissions using the second subset of frequency bands, and the second time period corresponds to a second time duration in which the one or more other network entities transmits using the second subset of frequency bands.

In some examples of the method, UEs, and non-transitory computer-readable medium described herein, the measuring may include operations, features, means, or instructions for determining a difference between a first interference level measured during the first time period and a second interference level measured during the second time period, and where the difference is indicated in the interference measurement report. In some examples of the method, UEs, and non-transitory computer-readable medium described herein, the measuring may include operations, features, means, or instructions for determining whether a difference between a first interference level measured during the first time period and a second interference level measured during the second time period exceeds a threshold value, and where the interference measurement report indicates whether the threshold value is exceeded. Some examples of the method, UEs, and non-transitory computer-readable medium described herein may further include operations, features, means, or instructions for receiving control signaling that indicates the threshold value.

In some examples of the method, UEs, and non-transitory computer-readable medium described herein, the measurement configuration includes one or more sub-band indices that indicate the first subset of frequency bands to be measured during the first time period and the second time period. In some examples of the method, UEs, and non-transitory computer-readable medium described herein, the interference measurement report indicates a difference in measurements of the first subset of frequency bands between the first time period and the second time period associated with one or more antenna panels associated with the first network entity.

Some examples of the method, UEs, and non-transitory computer-readable medium described herein may further include operations, features, means, or instructions for measuring at least a third subset of frequency bands during the first time period and the second time period, where the third subset of frequency bands are adjacent in frequency to the first subset of frequency bands or the second subset of frequency bands.

A method for wireless communication at a serving network entity is described. The method may include receiving, from a neighboring network entity, a sub-band interference cancellation feedback request that indicates a first subset of frequency bands for interference measurements, and first and second time periods for associated interference measurements, where the first subset of frequency bands is from a set of channel frequency bands used for wireless communications, transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the neighboring network entity, receiving, from the UE, a measurement report that is based on the first set of measurements and the second set of measurements, and transmitting, to the neighboring network entity, a sub-band interference cancellation feedback indication for the first subset of frequency bands that is based on the measurement report.

A serving network entity for wireless communication is described. The serving network entity may include one or more memories storing processor-executable code; and one or more processors coupled with the one or more memories. The one or more processors may be individually or collectively operable to execute the code to cause the cause the serving network entity to receive, from a neighboring network entity, a sub-band interference cancellation feedback request that indicates a first subset of frequency bands for interference measurements, and first and second time periods for associated interference measurements, where the first subset of frequency bands is from a set of channel frequency bands used for wireless communications, transmit, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the neighboring network entity, receive, from the UE, a measurement report that is based on the first set of measurements and the second set of measurements, and transmit, to the neighboring network entity, a sub-band interference cancellation feedback indication for the first subset of frequency bands that is based on the measurement report.

Another serving network entity for wireless communication is described. The serving network entity may include means for receiving, from a neighboring network entity, a sub-band interference cancellation feedback request that indicates a first subset of frequency bands for interference measurements, and first and second time periods for associated interference measurements, where the first subset of frequency bands is from a set of channel frequency bands used for wireless communications, means for transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the neighboring network entity, means for receiving, from the UE, a measurement report that is based on the first set of measurements and the second set of measurements, and means for transmitting, to the neighboring network entity, a sub-band interference cancellation feedback indication for the first subset of frequency bands that is based on the measurement report.

A non-transitory computer-readable medium storing code for wireless communication at a serving network entity is described. The code may include instructions executable by one or more processors to receive, from a neighboring network entity, a sub-band interference cancellation feedback request that indicates a first subset of frequency bands for interference measurements, and first and second time periods for associated interference measurements, where the first subset of frequency bands is from a set of channel frequency bands used for wireless communications, transmit, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the neighboring network entity, receive, from the UE, a measurement report that is based on the first set of measurements and the second set of measurements, and transmit, to the neighboring network entity, a sub-band interference cancellation feedback indication for the first subset of frequency bands that is based on the measurement report.

Some examples of the method, serving network entities, and non-transitory computer-readable medium described herein may further include operations, features, means, or instructions for receiving, from the neighboring network entity, a resource status request for a load associated with downlink resources used for communications with one or more UEs and transmitting, to the neighboring network entity, a resource status response that indicates whether the sub-band interference cancellation feedback request is allowed based on the load associated with the downlink resources used for communications with one or more UEs. In some examples of the method, serving network entities, and non-transitory computer-readable medium described herein, the first time period corresponds to a first time duration in which the neighboring network entity refrains from transmissions using the second subset of frequency bands, and the second time period corresponds to a second time duration in which the neighboring network entity transmits using the second subset of frequency bands. In some examples of the method, serving network entities, and non-transitory computer-readable medium described herein, the first time period corresponds to a first time duration in which the originating network entity transmits using the second subset of frequency bands based on a first interference cancellation procedure that is applied to the set of channel frequency bands, and the second time period corresponds to a second time duration in which the originating network entity transmits using the second subset of frequency bands based on a second interference cancellation procedure that is applied only to the second subset of frequency bands.

In some examples of the method, serving network entities, and non-transitory computer-readable medium described herein, the measurement report indicates a difference between a first interference level measured during the first time period and a second interference level measured during the second time period. In some examples of the method, serving network entities, and non-transitory computer-readable medium described herein, the measurement report indicates whether a difference between a first interference level measured during the first time period and a second interference level measured during the second time period exceeds a threshold value. In some examples of the method, serving network entities, and non-transitory computer-readable medium described herein, the sub-band interference cancellation feedback indication provides a difference in measured interference levels between the first time period and the second time period.

In some examples of the method, serving network entities, and non-transitory computer-readable medium described herein, the sub-band interference cancellation feedback request indicates one or more subsets of frequency bands for interference measurements. In some examples of the method, serving network entities, and non-transitory computer-readable medium described herein, the sub-band interference cancellation feedback indication provides downlink interference levels before and after transmissions of the neighboring network entity that use sub-band interference cancellation. In some examples of the method, serving network entities, and non-transitory computer-readable medium described herein, the sub-band interference cancellation feedback indication provides an indication of whether measured interference levels exceed a threshold value when the neighboring network entity transmits using sub-band interference cancellation only on frequency sub-bands allocated to the neighboring network entity for communications.

Some examples of the method, serving network entities, and non-transitory computer-readable medium described herein may further include operations, features, means, or instructions for determining the sub-band interference cancellation feedback indication according to one or more predetermined times for performing a sub-band interference cancellation procedure and transmitting, to the neighboring network entity, one or more subsequent sub-band interference cancellation feedback indications for the first subset of frequency bands in accordance with the one or more predetermined times for performing the sub-band interference cancellation procedure.

In some examples of the method, serving network entities, and non-transitory computer-readable medium described herein, the sub-band interference cancellation feedback indication may be based on one or more threshold values associated with one or more of a total physical resource block (PRB) usage of available downlink resources, a control channel element (CCE) usage of available downlink control channel resources, an amount of PRB usage for a synchronization signal block (SSB) area, a CCE usage of available downlink control channel resources for the SSB area, an amount of PRB usage for a network slice radio area, a CCE usage of available downlink control channel resources for the network slice radio area, an amount of PRB usage for multiple-input multiple-output (MIMO) resources, a CCE usage of available downlink control channel resources for the MIMO resources, of any combinations thereof.

In some examples of the method, serving network entities, and non-transitory computer-readable medium described herein, the sub-band interference cancellation feedback indication is based on a mapping table between interference measurements and two or more subsets of frequency bands of the set of channel frequency bands. In some examples of the method, apparatuses, and non-transitory computer-readable medium described herein, the second subset of frequency bands include only frequency sub-bands on which the neighboring network entity has allocations for communications with one or more associated UEs. In some examples of the method, serving network entities, and non-transitory computer-readable medium described herein, the sub-band interference cancellation feedback request may be received via an Xn interface and indicates sub-band interference cancellation activation or deactivation request and an indication of a quantity of downlink transmissions associated with the second time period. In some examples of the method, serving network entities, and non-transitory computer-readable medium described herein, the interference measurement report indicates a difference in measurements of the first subset of frequency bands between the first time period and the second time period associated with one or more antenna panels associated with the serving network entity.

A method for wireless communication at a neighboring network entity is described. The method may include transmitting, to a serving network entity that serves at least one UE using a first subset of frequency bands from a set of channel frequency bands used for wireless communications, a sub-band interference cancellation feedback request that indicates at least a first subset of frequency bands for interference measurements, and first and second time periods for associated interference measurements, receiving, from the serving network entity, a sub-band interference cancellation feedback indication for the first subset of frequency bands that is based on measured interference for at least the first subset of frequency bands that is reported to the serving network entity by the at least one UE, and activating a sub-band interference cancellation procedure to adjust a transmission power for communications using at least a second subset of frequency bands based on the sub-band interference cancellation feedback indication.

A neighboring network entity for wireless communication is described. The neighboring network entity may include one or more memories storing processor-executable code; and one or more processors coupled with the one or more memories. The one or more processors may be individually or collectively operable to execute the code to cause the neighboring network entity to transmit, to a serving network entity that serves at least one UE using a first subset of frequency bands from a set of channel frequency bands used for wireless communications, a sub-band interference cancellation feedback request that indicates at least a first subset of frequency bands for interference measurements, and first and second time periods for associated interference measurements, receive, from the serving network entity, a sub-band interference cancellation feedback indication for the first subset of frequency bands that is based on measured interference for at least the first subset of frequency bands that is reported to the serving network entity by the at least one UE, and activate a sub-band interference cancellation procedure to adjust a transmission power for communications using at least a second subset of frequency bands based on the sub-band interference cancellation feedback indication.

Another neighboring network entity for wireless communication is described. The neighboring network entity may include means for transmitting, to a serving network entity that serves at least one UE using a first subset of frequency bands from a set of channel frequency bands used for wireless communications, a sub-band interference cancellation feedback request that indicates at least a first subset of frequency bands for interference measurements, and first and second time periods for associated interference measurements, means for receiving, from the serving network entity, a sub-band interference cancellation feedback indication for the first subset of frequency bands that is based on measured interference for at least the first subset of frequency bands that is reported to the serving network entity by the at least one UE, and means for activating a sub-band interference cancellation procedure to adjust a transmission power for communications using at least a second subset of frequency bands based on the sub-band interference cancellation feedback indication.

A non-transitory computer-readable medium storing code for wireless communication at a neighboring network entity is described. The code may include instructions executable by one or more processors to transmit, to a serving network entity that serves at least one UE using a first subset of frequency bands from a set of channel frequency bands used for wireless communications, a sub-band interference cancellation feedback request that indicates at least a first subset of frequency bands for interference measurements, and first and second time periods for associated interference measurements, receive, from the serving network entity, a sub-band interference cancellation feedback indication for the first subset of frequency bands that is based on measured interference for at least the first subset of frequency bands that is reported to the serving network entity by the at least one UE, and activate a sub-band interference cancellation procedure to adjust a transmission power for communications using at least a second subset of frequency bands based on the sub-band interference cancellation feedback indication.

In some examples of the method, neighboring network entities, and non-transitory computer-readable medium described herein, the sub-band interference cancellation feedback request includes an indication of one or more allocated downlink sub-bands associated with the second subset of frequency bands. Some examples of the method, neighboring network entities, and non-transitory computer-readable medium described herein may further include operations, features, means, or instructions for transmitting, to the serving network entity, a resource status request for a load associated with downlink resources used for communications with one or more UEs and receiving a resource status response that indicates whether the sub-band interference cancellation feedback request is allowed based on the load associated with the downlink resources used for communications with one or more UEs. In some examples of the method, neighboring network entities, and non-transitory computer-readable medium described herein, the sub-band interference cancellation feedback indication provides a difference in measured interference levels between the first time period and the second time period.

In some examples of the method, neighboring network entities, and non-transitory computer-readable medium described herein, the sub-band interference cancellation feedback request indicates one or more subsets of frequency bands for interference measurements.

In some examples of the method, neighboring network entities, and non-transitory computer-readable medium described herein, the sub-band interference cancellation feedback indication provides downlink interference levels before and after transmissions that use sub-band interference cancellation. In some examples of the method, neighboring network entities, and non-transitory computer-readable medium described herein, the sub-band interference cancellation feedback indication provides an indication of whether measured interference levels exceed a threshold value when the neighboring network entity transmits using sub-band interference cancellation only on frequency sub-bands allocated to the neighboring network entity for communications. Some examples of the method, neighboring network entities, and non-transitory computer-readable medium described herein may further include operations, features, means, or instructions for receiving the sub-band interference cancellation feedback indication according to one or more predetermined times for performing a sub-band interference cancellation procedure. In some examples of the method, neighboring network entities, and non-transitory computer-readable medium described herein, the sub-band interference cancellation feedback indication is based on a mapping table between interference measurements and two or more subsets of frequency bands of the set of channel frequency bands.

### BRIEF DESCRIPTION OF THE DRAWINGS

FIG. 1 illustrates an example of a wireless communications system that supports sub-band interference cancellation (SBIC) techniques for network energy savings in accordance with one or more aspects of the present disclosure.

FIG. 2 illustrates an example of a wireless communications system that supports SBIC techniques for network energy savings in accordance with one or more aspects of the present disclosure.

FIG. 3 illustrates an example of digital pre-distortion on allocated sub-bands versus across a system bandwidth in accordance with one or more aspects of the present disclosure.

FIG. 4 illustrates an example of a process flow that supports SBIC techniques for network energy savings in accordance with one or more aspects of the present disclosure.

FIGS. 5 and 6 show block diagrams of devices that support SBIC techniques for network energy savings in accordance with one or more aspects of the present disclosure.

FIG. 7 shows a block diagram of a communications manager that supports SBIC techniques for network energy savings in accordance with one or more aspects of the present disclosure.

FIG. 8 shows a diagram of a system including a device that supports SBIC techniques for network energy savings in accordance with one or more aspects of the present disclosure.

FIGS. 9 and 10 show block diagrams of devices that support SBIC techniques for network energy savings in accordance with one or more aspects of the present disclosure.

FIG. 11 shows a block diagram of a communications manager that supports SBIC techniques for network energy savings in accordance with one or more aspects of the present disclosure.

FIG. 12 shows a diagram of a system including a device that supports SBIC techniques for network energy savings in accordance with one or more aspects of the present disclosure.

FIGS. 13 through 20 show flowcharts illustrating methods that support SBIC techniques for network energy savings in accordance with one or more aspects of the present disclosure.

### DETAILED DESCRIPTION

A wireless communications system may include a communication device, such as a user equipment (UE) or a network entity (e.g., an eNodeB (eNB), a next-generation NodeB or a giga-NodeB, either of which may be referred to as a gNB, or some other base station), that support wireless communications over one or multiple radio access technologies. Examples of radio access technologies include 4G systems, such as LTE systems, 5G systems, which may be referred to as NR systems, or other radio access technologies. The wireless communications may include uplink transmission, uplink reception, downlink transmission, or downlink reception, sidelink transmission, sidelink reception, or a combination thereof. A communication device may be configured with various circuitry to support wireless communications. In some cases, this various circuitry may include non-linear circuit elements, such as a power amplifier. A power amplifier may have a limited linear dynamic range (e.g., a difference between the communication device's maximum input power and a minimum measurable power) and, as a result, may distort the wireless communication (e.g., signals) due to high peak to average power ratio (PAPR).

In some cases, to avoid the distortion of the wireless communication, the communication device may be configured to support output power back-off operations (e.g., reducing a power level for the power amplifier). Output power back-off may be defined as a power level at an output of the power amplifier relative to a maximum output level possible using the power amplifier. However, the higher an output power back-off value, the lower the efficiency of the power amplifier. Some techniques for decreasing or mitigating distortion of wireless communication (e.g., signals) are suboptimal and lack in efficiency, performance, resource cost, and may limit the dynamic range of the wireless communication (e.g., signals).

Various aspects of the present disclosure relate to enabling the network to control non-linear distortion characteristics for one or more communication devices (e.g., a UE, a base station, an integrated access and backhaul (IAB) node, or any combination thereof), and manage a network throughput and efficiency. In some cases, techniques for controlling such non-linear distortion may provide that a network entity performs digital pre-distortion (DPD) or sub-band interference cancellation (SBIC) for downlink transmissions. SBIC may help save energy by allowing power amplifiers to operate in a linear region which is more efficient, and using SBIC for downlink can help network entities save power as well. Further, applying SBIC across an entire operating bandwidth can consume more power than applying SBIC only in a subset of frequency bands (e.g., frequency bands used for communications between a network entity applying SBIC and a served UE), and thus applying SBIC in allocated frequency bands may be desirable. However, applying SBIC only in allocated frequency sub-bands of UEs that are served by a network entity may result in higher interference in adjacent sub-bands, which may be used by neighboring network entities for communications with their associated UEs. Various techniques as discussed herein provide for determining whether UEs served by neighboring network entities are subjected to additional sub-band interference from SBIC only on allocated sub-bands of a transmitting network entity, and a determination to activate or deactivate sub-band specific SBIC may be based on measurements of the additional sub-band interference.

In accordance with various aspects, described techniques provide that an originating network entity may request SBIC information from one or more neighboring network entities for one or more sub-bands, where the neighboring network entities serve at least one UE using adjacent sub-bands. In some cases, the originating network entity may exchange information related to sub-bands of interest to the one or more neighboring network entities, and whether SBIC is to be activated or not for only the identified sub-bands (e.g., versus across all operating sub-bands). The one or more neighboring network entities may configure measurement reporting by the UE for multiple time periods, corresponding to when transmissions are present and absent from the allocated sub-band(s) of the originating network entity. The one or more UEs may report a difference in measured interference between the two time periods, or measured values for each time period. A neighboring network entity that serves the UE may receive the measurement report and determine whether SBIC for the allocated sub-band is to be activated or not, and may signal the determination to the originating network entity. In some cases, network entities may initiate the allocated-sub-band SBIC based on loading at each network entity being below a threshold level. Additionally, or alternatively, network entities may establish defined times at which the procedures are performed (e.g., based on a time of day when network loading is expected to be low).

Aspects of the disclosure are initially described in the context of wireless communications systems. Aspects of the disclosure are further illustrated by and described with reference to SBIC properties, process flows, apparatus diagrams, system diagrams, and flowcharts that relate to SBIC techniques for network energy savings.

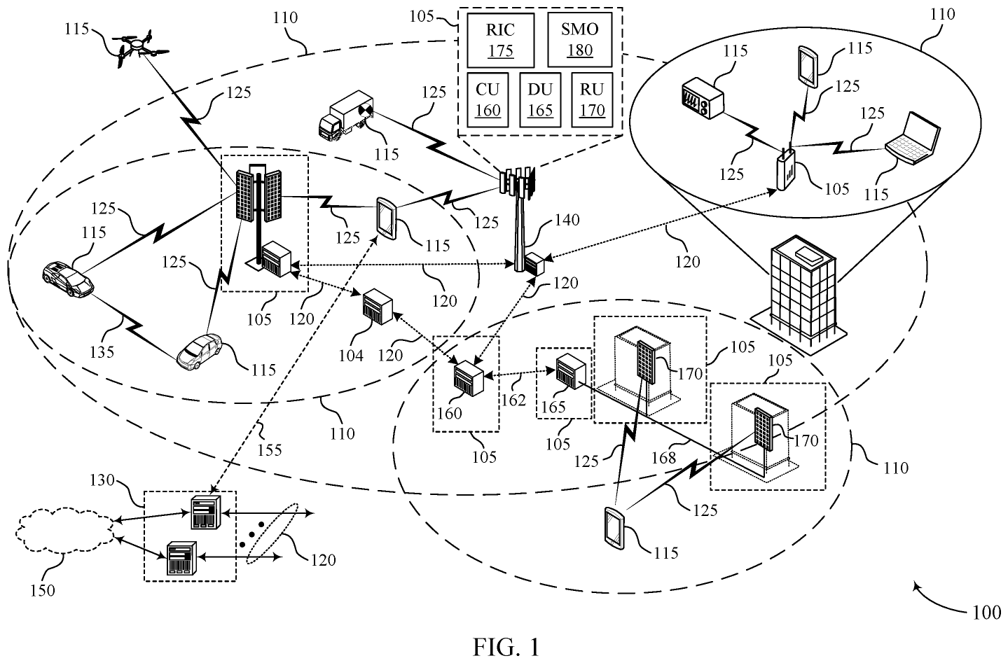

FIG. 1 illustrates an example of a wireless communications system 100 that supports SBIC techniques for network energy savings in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SBIC techniques for network energy savings as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, various factors, for example, such as efficiency use of resources including radiated power by a network entity 105, a base station 140, or a UE 115, or any combination thereof may impact performance of the wireless communications system 100. The network entity 105, the base station 140, or the UE 115, or any combination thereof, may be equipped with various circuitry, including non-linear circuit elements, such as power amplifiers that may have a limited linear dynamic range. Due to the limited dynamic range of these power amplifiers and high PAPR, wireless communication (e.g., signal transmissions) in the wireless communications system 100 may be distorted. The non-linear distortions may be classified as in-band distortion (IBD), which impact the communication link (e.g., a communication link 120, a communication link 125, or a communication link 135 performance in sense of mutual information or/and error vector magnitude (EVM), and out-band distortion (OBD), which may define the amount of adjacent channel interference (ACI) or in band emissions (IBE). The ACI may indicate how much an adjacent channel is polluted (e.g., congested) by a transmission, while the IBE is similarly to ACI, but in the same channel. In order to avoid the distortions, output power back-off may be supported, however the output power back-off comes with a cost. The higher the output power back-off, the less power amplifier power efficiency the network entity 105, the base station 140, or the UE 115, or any combination thereof experience. As such, less power is provided to a channel, while more power is dissipated as heat.

In some other cases, a network entity 105, a base station 140, or a UE 115, or any combination thereof may support crest factor reduction (CFR) and digital pre-distortion (DPD) techniques to improve wireless communication quality and coverage while reducing the wireless communications system 100 operating costs. For example, the CFR techniques may reduce a dynamic range of wireless communication (e.g., signals), while the DPD techniques may linearize a power amplifier response. As a result, the output power back-off is reduced, and the power amplifier efficiency is improved. In other cases, the wireless communications system 100 may support SBIC that may control a location in frequency where a non-linear distortion is concentrated. In some examples, the SBIC may reduce in-band EVM. In some examples, the SBIC may reduce in-band EVM on a respective component carrier. In some examples, the SBIC may reduce adjacent out-of-band EVM.

In the wireless communications system 100, a network entity 105 may support measurements of adjacent channel interference for SBIC (e.g., a first interference cancellation procedure that is applied only to a subset of frequency sub-bands) versus application of DPD (e.g., a second interference cancellation procedure) across an operating bandwidth of the network entity 105. In some cases, an originating network entity 105 may request SBIC information from one or more neighboring network entities 105 for one or more allocated sub-bands associated with the originating network entity 105, where the neighboring network entities 105 serve one or more UEs 115 using one or more sub-bands that are adjacent to the allocated sub-bands. The originating network entity 105 may determine to initiate SBIC on the allocated sub-bands based at least in part on feedback provided from one or more of the neighboring network entities 105. Such techniques may provide for network power savings at the originating network entity 105 (e.g., through application of SBIC on downlink transmissions using the allocated sub-bands with no DPD on other sub-bands), and mitigation of potential interference in cases where the SBIC only on allocated sub-bands would generate excessive interference at one or more UEs 115 served by the neighboring network entities.

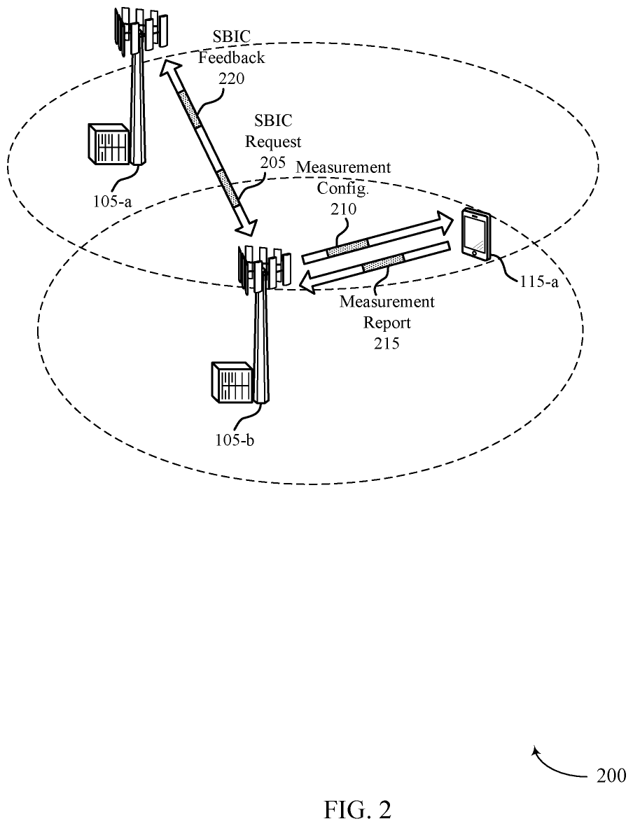

FIG. 2 illustrates an example of a wireless communications system 200 that supports SBIC techniques for network energy savings in accordance with one or more aspects of the present disclosure. The wireless communications system 200 may implement or be implemented by aspects of the wireless communications system 100 as described in FIG. 1. For example, the wireless communications system 200 may include a network entity 105-a (e.g., a first network entity or an originating network entity, that originates an SBIC request), a network entity 105-b (e.g., a neighboring network entity or a serving network entity that serves one or more UEs 115 that provide SBIC measurement reports), and a UE 115-a, which may be examples of network entities 105 and UEs 115 as described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support power saving, and, in some examples, may promote high reliability and low latency wireless communications.

One or more of the network entity 105-a, the network entity 105-b, or the UE 115-a, or any combination thereof, may be equipped with multiple antennas, which may be used to employ techniques as described with reference to FIG. 1. The antennas of one or more of the network entity 105-a, the network entity 105-b, or the UE 115-a, or any combination thereof, may be located within one or more antenna arrays or antenna panels, which may support operations as described herein. The network entity 105-a, the network entity 105-b, or both, may have an antenna array with a number of rows and columns of antenna ports that the network entity 105-a, the network entity 105-b, or both may use to support wireless communications (e.g., with the UE 115-a). Likewise, the UE 115-a may have one or more antenna arrays that may support various operations as described herein. Additionally or alternatively, the UE 115-a may have an antenna array with a number of rows and columns of antenna ports that the UE 115-a may use to support wireless communications (e.g., with the network entity 105-b).

One or more antennas or antenna arrays of one or more of the network entity 105-a, the network entity 105-b, or the UE 115-a, or any combination thereof may be part of a transmit chain, a receiver chain, or both. A transmit chain may refer to a number of antennas including other circuit elements, which may include amplifiers, filters, mixers, attenuators, and detectors that are configured for transmitting signals (e.g., control information, data). A receiver chain may refer to a number of antennas including other circuit elements, which may include amplifiers, filters, mixers, attenuators, and detectors that are configured for receiving signals (e.g., control information, data).

In some cases, one or more of the network entity 105-a, the network entity 105-b, or the UE 115-a, or any combination thereof may be configured with various circuitry to support wireless communications as described herein. In some cases, this various circuitry may include non-linear circuit elements, such as a power amplifier. A power amplifier may have a limited linear dynamic range (e.g., a difference between the device's maximum input power and a minimum measurable power) and, as a result, may distort the wireless communication (e.g., signals) due to high PAPR. In some cases, to avoid the distortion of the wireless communication, one or more of the network entity 105-a, the network entity 105-b, or the UE 115-a, or any combination thereof may be configured to support output power back-off operations (e.g., reducing a power level for the power amplifier). Output power back-off may be defined as a power level at an output of the power amplifier relative to a maximum output level possible using the power amplifier. However, the higher an output power back-off value, the lower the efficiency of the power amplifier. Some techniques for decreasing or mitigating distortion of wireless communication (e.g., signals) are suboptimal and lack in efficiency, performance, resource cost, and may limit the dynamic range of the wireless communication (e.g., signals).

In the example of FIG. 2, a respective network entity 105 may control non-linear distortion characteristics for downlink communications, and may perform SBIC based on adjacent channel interference measurement reports in accordance with various techniques as discussed herein. In some examples, the network entity 105-a may act as an originating network entity 105-a that originates a SBIC request 205 to neighboring network entity 105-b. In some cases, the SBIC request 205 is for information for an allocated sub-band of the originating network entity 105-a, where the neighboring network entity 105-b serves UE 115-a using one or more sub-bands that are adjacent to the allocated sub-band of the originating network entity 105-a. In some cases, the SBIC request may indicate information related to sub-bands of interest, and the neighboring network entity 105-b may determine measurements that are to be made at the UE 115-a, and transmit a measurement configuration 210 to the UE 115-a. The measurement configuration 210 may indicate that the UE 115-a is to perform interference measurements for one or more sub-bands (e.g., an adjacent sub-band to the allocated sub-band of the originating network entity 105-a) at two different time periods.

In some cases, a first time period of the two different time periods corresponds to a time period during which the originating network entity 105-a is not transmitting on an adjacent sub-band to the measurement sub-band of the UE 115-a, or during which the originating network entity transmits using DPD across all sub-bands. A second time period of the two different time periods may correspond to a time period during which the originating network entity 105-a transmits on the allocated sub-band of the originating network entity 105-a using SBIC in which interference cancellation is performed only on the allocated sub-band. The UE 115-a may perform channel measurements for the different time periods, and transmit a measurement report 215 to the neighboring network entity 105-b. In some cases, the neighboring network entity 105-b may transmit SBIC feedback 220 to the originating network entity 105-a based at least in part on the measurement report 215. In some cases, the SBIC feedback may indicate whether SBIC is to be activated or not for only the identified sub-bands (versus across all operating sub-bands).

In some cases, the SBIC request 205 and the SBIC feedback 220 may be exchanged between the respective network entities 105 via an Xn interface. In some cases, the measurement configuration 210 and the measurement report 215 may be exchanged between the network entity 105-b and the UE 115-a via a Uu interface. In some cases, the measurement report 215 may indicate a difference in measured interference between the two time periods, or may provide separate measured values for each time period. In some cases, the measurement report 215 may indicate whether a difference in measured interference exceeds a threshold value. In some cases, the threshold value may be indicated to the UE 115-a with the measurement configuration 210, or may be provided in separate signaling (e.g., via RRC signaling, via a medium access control (MAC) control element (CE), via downlink control information (DCI), or any combinations thereof). In some cases, the network entities 105 may initiate the allocated-sub-band SBIC based on loading at each network entity 105 being below a threshold level. Additionally, or alternatively, the network entities 105 may establish defined times at which the procedures are performed (e.g., based on a time of day when network loading is expected to be low).

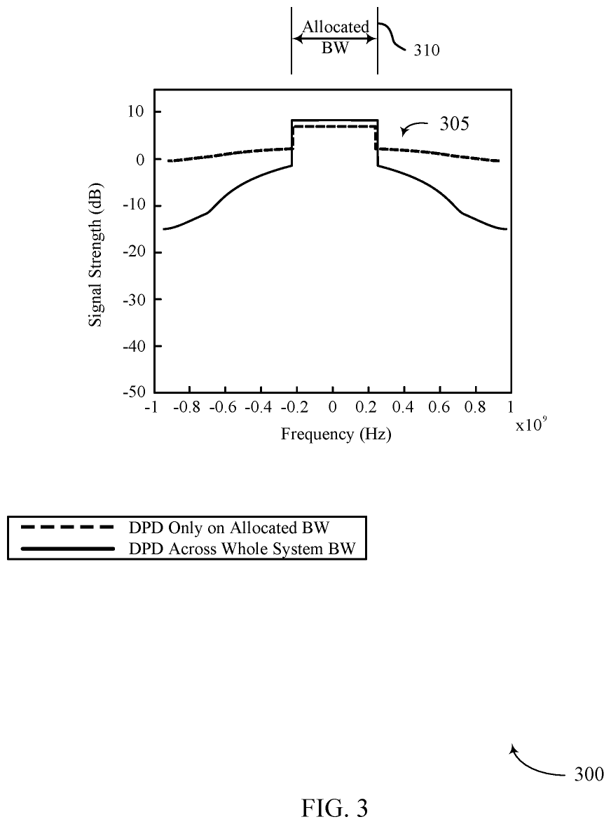

FIG. 3 illustrates an example 300 of digital pre-distortion on allocated sub-bands versus across a system bandwidth in accordance with one or more aspects of the present disclosure. The example 300 may represent signal characteristics of communications in aspects of the wireless communications systems 100 and 200 as described with reference to FIGS. 1 and 2, respectively. The example 300 illustrates non-linear distortion characteristics of a waveform 305 (e.g., downlink wireless communication) in which DPD is applied only on a network entity's allocated bandwidth 310 (e.g., a subset of frequency bands) or across a whole system bandwidth (e.g., a set of frequency bands).

As can be observed from the waveform 305, a signal strength outside of the allocated bandwidth 310 is higher when DPD (e.g., SBIC) is applied only for the allocated bandwidth 310 versus when DPD is applied across the whole system bandwidth. In cases where a neighboring network entity is operating using an adjacent bandwidth (e.g., an adjacent subset of frequency bands to the allocated bandwidth 310), the additional interference in cases where DPD is applied only for the allocated bandwidth 310 may result in unreliable communications between the neighboring network entity and one or more served UEs. In accordance with various aspects as discussed herein, an originating network entity may request feedback from one or more neighboring network entities to confirm that SBIC only on the allocated bandwidth 310 would be acceptable.

In some cases, applying sub-band interference cancellation (SBIC) for downlink transmissions from a network entity may provide a lower peak-to-average power ratio (PAPR) while maintaining EVM targets for communications. The lower PAPR allows for additional power back off relaxation and lower network entity power consumption, with the drawback that UEs operating in other sub-bands outside the allocated bandwidth 310 might receive downlink interference. In accordance with various aspects, SBIC may be implemented by a network entity based on information from one or more neighboring network entities related to interference generated from the SBIC only on the allocated bandwidth 310. In some deployments, such as sparse deployments in areas with relatively low quantities of UEs, or under some low load conditions (e.g., overnight hours in office or retail environments), network devices may determine to limit the DPD operation only in the allocated bandwidth 310. DPD operation only in allocated bandwidth 310 and not across the whole system bandwidth may reduce network energy consumption, due to lower PAPR values which implies lower power back-off values. In some cases, downlink interference from UEs served by neighboring network entities may be reported to an originating network entity.

In some cases, network entities may perform semi-static or dynamic SBIC activation and deactivation, and associated back-off adaptation for downlink transmissions from the network entity. The originating network entity may signal to neighboring base stations of potential downlink interference, and the neighboring network entities may collect downlink interference measurements from UEs in their cells operating in sub-bands outside the sub-bands in which SBIC is applied. The neighboring base stations may report the downlink interference measurements to the originating network entity. In some cases, the procedure may be triggered either by a neighbor network entity (e.g., when an observed cell load in terms of downlink total physical resource block (PRB) usage goes below X %, after being requested to report resource status), or jointly where a network entity seeking to perform SBIC and hence adapt its backoff can request a RESOURCE STATUS from all neighbor network entities and upon reception of a RESOURCE STATUS RESPONSE indicating low load, or by a neighboring network entity reporting a RESOURCE STATUS RESPONSE without being requested to do so that indicates a low load (e.g., “SBIC allowed”). Additionally, or alternatively, the procedure may be initiated according to a previous agreement of network entities to one or more trigger conditions or threshold values, such as, for example:
downlink total PRB usage<X;
downlink scheduling physical downlink control channel (PDCCH) control channel element (CCE) usage<Y;
synchronization signal block (SSB) area downlink total PRB usage<Z;
SSB area downlink scheduling PDCCH CCE Usage<N;
slice radio area downlink total PRB usage<K;
slice radio area downlink scheduling PDCCH CCE Usage<L;
MIMO downlink total PRB usage<M;
MIMO downlink scheduling PDCCH CCE usage<P;
any of the above for downlink guaranteed bit rate (GBR); or any combinations thereof.

In some cases, additionally or alternatively, a neighboring network entity and an originating network entity may agree to start the procedure of RESOURCE STATUS exchange at a certain time of day (e.g., X time of the day Z) for one or more days. In some cases, the network entities may start the SBIC measurement and feedback procedure automatically without exchanging RESOURCE STATUS at the agreed times.

In some cases, upon SBIC activation and back-off adaptation, the downlink sub-band interference levels onto different sub-bands is obtained. In some cases, a mapping table between downlink sub-band interference in the non-allocated sub-bands may be generated internally at the network entity (e.g., via measurements or tests) is available. In some cases, the expected value of downlink interference per sub-band is reported. In some cases, one or more time slots (or sub-slots) in which SBIC will be effective is also exchanged via the Xn interface. Implicitly, the originating network entity might request the neighboring network entity to perform SBIC on the same allocated sub-bands in which the originating network entity has allocated its UEs.

In accordance with various aspects, the measurement report(s) provided by UEs to the one or more neighboring network entities may provide an estimation of the impact of SBIC activation that is measured in terms of downlink interference at the sub-bands that are “receiving” this interference, which include downlink sub-bands outside the scheduled sub-bands of the originating network entity. A comparison of downlink interference as reported by UEs in the neighboring cell before and after SBIC activation may be used to determine whether to activate SBIC at the originating network entity. In some cases, measurements at the UEs may be made using one or more reference signal transmissions (e.g., channel state information reference signals (CSI-RSs), zero-power (ZP) CSI-RSs for interference measurement, non-ZP CSI-RS for signal to interference and noise ratio (SINR) comparison, or any combinations thereof). In some cases, signaling may be provided for the UEs to report the downlink interference difference on certain sub-bands (e.g., before and after SBIC). In some cases, network entities may exchange information (e.g., via an Xn interface) that may include either SBIC activation/deactivation command/suggestion on certain downlink sub-bands, or simply downlink interference difference (e.g., before and after SBIC activation) for a number (e.g., K, where K is configurable or predetermined) of consecutive downlink interference measurements. In some cases, SBIC may be easier to activate in case of either a single UE with downlink traffic in a cell, or relatively few UEs are present with granted contiguous/adjacent downlink sub-bands. In case of multiple antenna panels in the same originating network entity, SBIC activation in certain downlink sub-bands served by one panel might generate interference in sub-bands served by other panel. In such cases, downlink interference spilling across panels may be managed by the network entity scheduler.

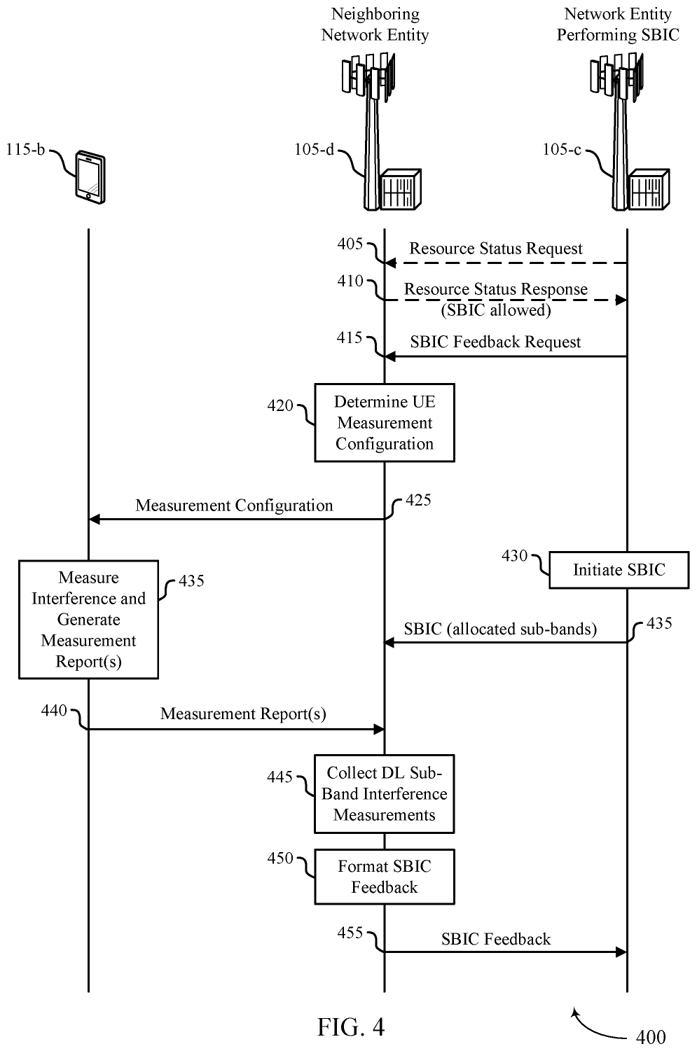

FIG. 4 illustrates an example of a process flow 400 that supports SBIC techniques for network energy savings in accordance with one or more aspects of the present disclosure. In some examples, the process flow 400 may implement or be implemented by aspects of the wireless communications system 100 and the wireless communications system 200 as described with reference to FIGS. 1 and 2, respectively. For example, the process flow 400 may be implemented by a network entity 105-c, a network entity 105-d, and a UE 115-b, which may be examples of a network entity 105 and a UE 115 as described with reference to FIGS. 1 and 2. The process flow 400 may be implemented by the network entity 105-c, the network entity 105-d, and the UE 115-b to exchange signaling to promote network entity power saving and reliable communications between one or more of the network entity 105-c, the network entity 105-d, and the UE 115-b. In the following description of the process flow 400, the operations between the network entity 105-c, the network entity 105-d, and the UE 115-b may be transmitted in a different order than the example order shown, or the operations performed by the network entity 105-c, the network entity 105-d, and the UE 115-b may be performed in different orders or at different times. Some operations may also be omitted from the process flow 400, and other operations may be added to the process flow 400.

At 405, optionally, the network entity 105-c, which may be an originating network entity 105-c that is seeking to perform SBIC, may transmit a resource status request to the neighboring network entity 105-d. In some cases, the resource status request may be transmitted based on a traffic load at the network entity 105-c that is seeking to perform SBIC. In some cases, additionally or alternatively, the resource status request may be transmitted based on a predetermined timing (e.g., based on a time of day, day of the week, or combinations thereof). The network entity 105-c and the network entity 105-d may communicate the over a backhaul interface (e.g., an Xn interface).

At 410, optionally, the neighboring network entity 105-d may transmit a resource status response to the originating network entity 105-c. In some cases, the resource status response may indicate that SBIC is allowed at the neighboring network entity 105-d. In some cases, the resource status response may be based on a traffic load at the neighboring network entity 105-d (e.g., based on one or more load threshold values such as discussed with reference to FIG. 3). In some cases, additionally or alternatively, the resource status request may be transmitted based on a predetermined timing (e.g., based on a time of day, day of the week, or combinations thereof).

At 415, the originating network entity 105-c may transmit a SBIC feedback request to the neighboring network entity 105-d. In some cases, the SBIC feedback request may be transmitted based on the resource status response from the neighboring network entity 105-d indicating that SBIC is allowed. In some cases, the exchange of the resource status request and associated response may be skipped by the originating network entity 105-c and the neighboring network entity 105-d (e.g., based on a predetermined time of day and/or day of the week that is exchanged between the network entities), and the SBIC feedback request may be transmitted directly from the originating network entity 105-d without prior exchange of information.

At 420, the neighboring network entity 105-d may determine a UE 115-b measurement configuration. In some cases, the measurement configuration may be determined based at least in part on an indication of an allocated sub-band (e.g., a second subset of frequency bands) of the originating network entity 105-c. In some cases, the neighboring network entity 105-d may communicate with the UE 115-b via one or more sub-bands (e.g., a first subset of frequency bands) that are adjacent sub-bands to the allocated sub-band of the originating network entity 105-c. In some cases, the measurement configuration may indicate a first time period and a second time period during which the UE 115-b is to perform channel measurements (e.g., SINR measurements) of the one or more sub-bands that are adjacent to the allocated sub-band of the originating network entity 105-c. In some cases, the first time period corresponds to a time duration during which the originating network entity 105-d does not transmit via the allocated sub-bands, or transmits via the allocated sub-bands using DPD across the whole system bandwidth. In some cases, the measurement configuration may indicate that the UE 115-b is to measure multiple different subsets of sub-bands, which may include the allocated sub-band and one or more adjacent sub-bands. At 425, the neighboring network entity 105-d may transmit the measurement configuration to the UE 115-b (e.g., via downlink control information transmitted via a Uu interface, that indicates a measurement report configuration).

At 430, the originating network entity 105-c may initiate the SBIC process. In some cases, the SBIC process may provide that the originating network entity 105-c transmits one or more reference signals (e.g., CSI-RSs) via the allocated sub-band during the second time period using SBIC only on the allocated sub-band, and does not transmit using the allocated sub-band during the first time period. In other cases, the originating network entity 105-c may transmit one or more reference signals (e.g., CSI-RSs) via the allocated sub-band using DPD that spans the while system bandwidth during the first time period, and transmit one or more reference signals (e.g., CSI-RSs) via the allocated sub-band during the second time period using SBIC only on the allocated sub-band.

At 435, UE 115-b may measure interference in accordance with the measurement configuration, and may generate a measurement report. In some cases, the measurement report may include an indication of a difference in measured interference levels between the first time period and the second time period. In some cases, the measurement report may include separate measurement values for both the first time period and the second time period. In further cases, the measurement report may include an indication of whether a difference in measured interference values in the first time period and the second time period exceeds a threshold value. In some cases, the threshold value may be a predetermined value, a specified value, or a value indicated with the measurement configuration, for example.

At 440, the UE 115-b may transmit the measurement report to the neighboring network entity 105-d. At 445, the neighboring network entity 105-d may collect downlink sub-band interference measurements from the UE 115-b and any other UEs that are configured with the measurement configuration. At 450, the neighboring network entity 105-d may format SBIC feedback based at least in part on the collected downlink sub-band interference measurements. In some cases, the neighboring network entity 105-d may determine that SBIC should not be initiated at the originating network entity 105-c based on measured interference values from one or more UEs indicating that out-of-band interference from the allocated sub-band is too high to support reliable communications between the neighboring network entity 105-d and the UE 115-b (and/or other served UEs). At 455, the neighboring network entity 105-d may transmit SBIC feedback to the originating network entity 105-c. In cases where the SBIC feedback indicates that SBIC may be activated, the originating network entity 105-c may use SBIC for communications in the allocated sub-band, which may allow for additional back-off reduction for downlink communications from the originating network entity 105-c, which may reduce network power consumption while providing reliable communications in the network.

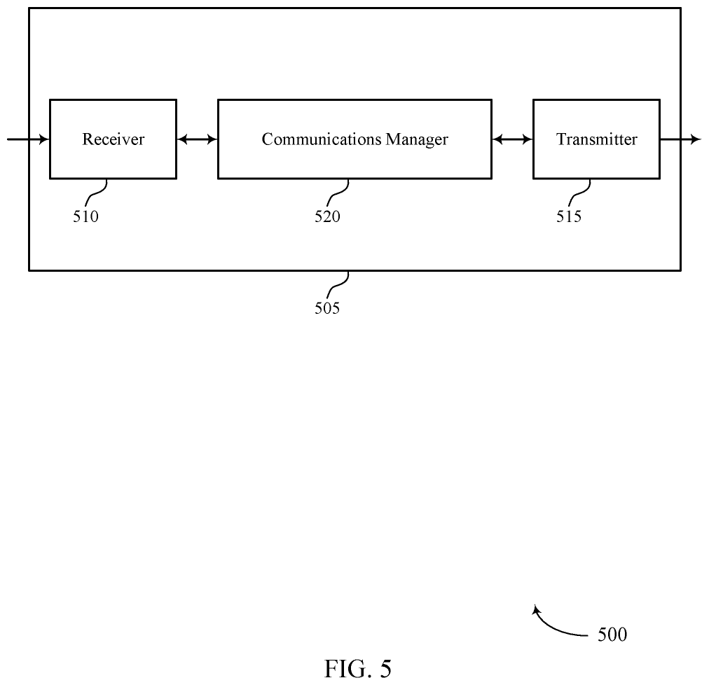

FIG. 5 shows a block diagram 500 of a device 505 that supports SBIC techniques for network energy savings in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to SBIC techniques for network energy savings). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SBIC techniques for network energy savings). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of SBIC techniques for network energy savings as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The communications manager 520 may be configured as or otherwise support a means for measuring the first subset of frequency bands during the first time period and the second time period. The communications manager 520 may be configured as or otherwise support a means for transmitting, responsive to the measuring, an interference measurement report to the first network entity based on the measurement configuration and a difference in measurements of the first subset of frequency bands between the first time period and the second time period.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for SBIC activation based on adjacent sub-band interference measurements, which may reduce network power consumption while providing reliable communications in the network.

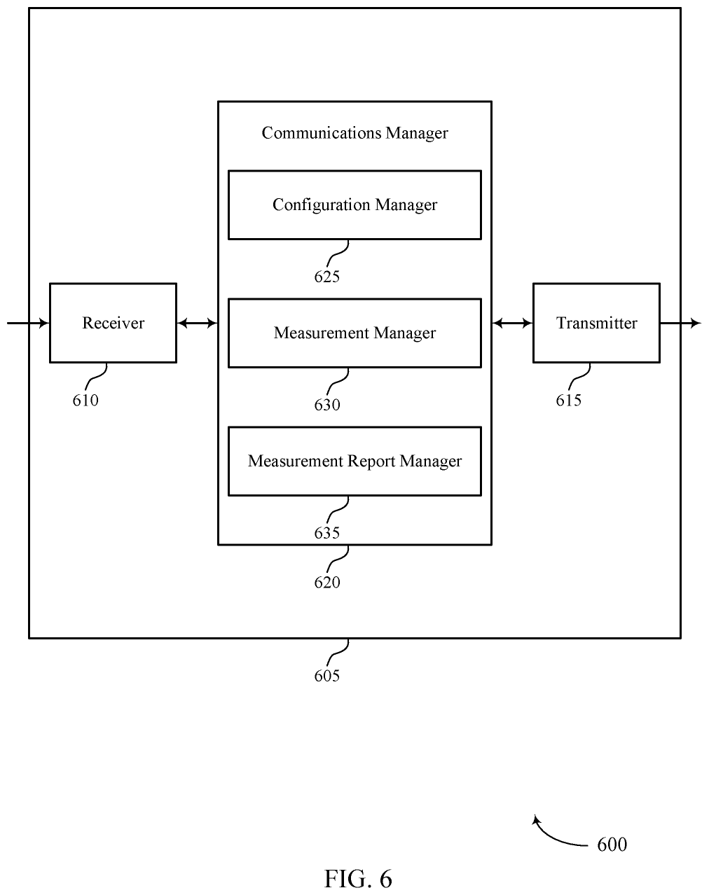

FIG. 6 shows a block diagram 600 of a device 605 that supports SBIC techniques for network energy savings in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to SBIC techniques for network energy savings). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SBIC techniques for network energy savings). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SBIC techniques for network energy savings as described herein. For example, the communications manager 620 may include a configuration manager 625, a measurement manager 630, a measurement report manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The configuration manager 625 may be configured as or otherwise support a means for receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The measurement manager 630 may be configured as or otherwise support a means for measuring the first subset of frequency bands during the first time period and the second time period. The measurement report manager 635 may be configured as or otherwise support a means for transmitting, responsive to the measuring, an interference measurement report to the first network entity based on the measurement configuration and a difference in measurements of the first subset of frequency bands between the first time period and the second time period.

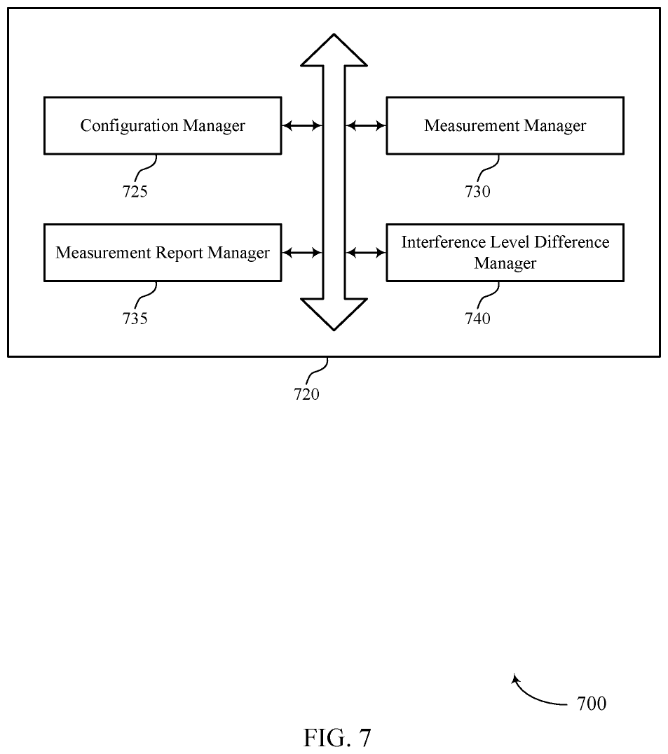

FIG. 7 shows a block diagram 700 of a communications manager 720 that supports SBIC techniques for network energy savings in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SBIC techniques for network energy savings as described herein. For example, the communications manager 720 may include a configuration manager 725, a measurement manager 730, a measurement report manager 735, an interference level difference manager 740, or any combination thereof. Each of these components may communicate, directly or indirectly, with one another (e.g., via one or more buses).

The communications manager 720 may support wireless communication at a UE in accordance with examples as disclosed herein. The configuration manager 725 may be configured as or otherwise support a means for receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The measurement manager 730 may be configured as or otherwise support a means for measuring the first subset of frequency bands during the first time period and the second time period. The measurement report manager 735 may be configured as or otherwise support a means for transmitting, responsive to the measuring, an interference measurement report to the first network entity based on the measurement configuration and a difference in measurements of the first subset of frequency bands between the first time period and the second time period. In some examples, the first time period corresponds to a first time duration in which the one or more other network entities refrain from transmissions using the second subset of frequency bands, and the second time period corresponds to a second time duration in which the one or more other network entities transmits using the second subset of frequency bands.

In some examples, to support measuring, the interference level difference manager 740 may be configured as or otherwise support a means for determining a difference between a first interference level measured during the first time period and a second interference level measured during the second time period, and where the difference is indicated in the interference measurement report. In some examples, to support measuring, the interference level difference manager 740 may be configured as or otherwise support a means for determining whether a difference between a first interference level measured during the first time period and a second interference level measured during the second time period exceeds a threshold value, and where the interference measurement report indicates whether the threshold value is exceeded.

In some examples, the interference level difference manager 740 may be configured as or otherwise support a means for receiving control signaling that indicates the threshold value. In some examples, the measurement configuration includes one or more sub-band indices that indicate the first subset of frequency bands to be measured during the first time period and the second time period. In some examples, the interference measurement report indicates a difference in measurements of the first subset of frequency bands between the first time period and the second time period associated with one or more antenna panels associated with the first network entity.

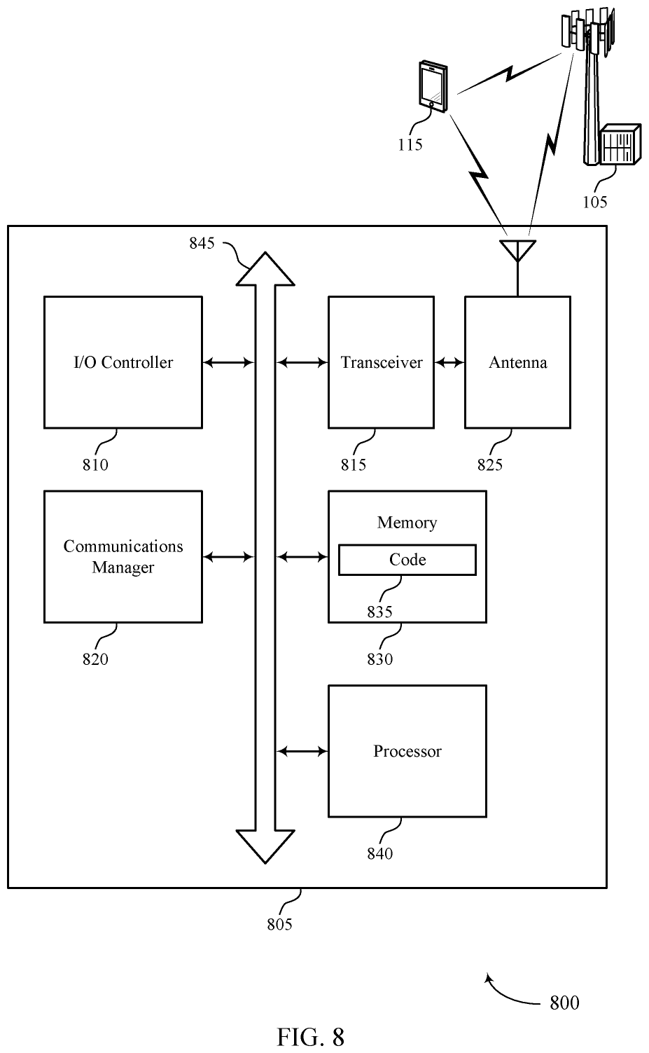

FIG. 8 shows a diagram of a system 800 including a device 805 that supports SBIC techniques for network energy savings in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting SBIC techniques for network energy savings). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The communications manager 820 may be configured as or otherwise support a means for measuring the first subset of frequency bands during the first time period and the second time period. The communications manager 820 may be configured as or otherwise support a means for transmitting, responsive to the measuring, an interference measurement report to the first network entity based on the measurement configuration and a difference in measurements of the first subset of frequency bands between the first time period and the second time period.

By including or configuring the communications manager 820 in accordance with examples as described herein, the device 805 may support techniques for SBIC activation based on adjacent sub-band interference measurements, which may reduce network power consumption while providing reliable communications in the network.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of SBIC techniques for network energy savings as described herein, or the processor 840 and the memory 830 may be otherwise configured to perform or support such operations.

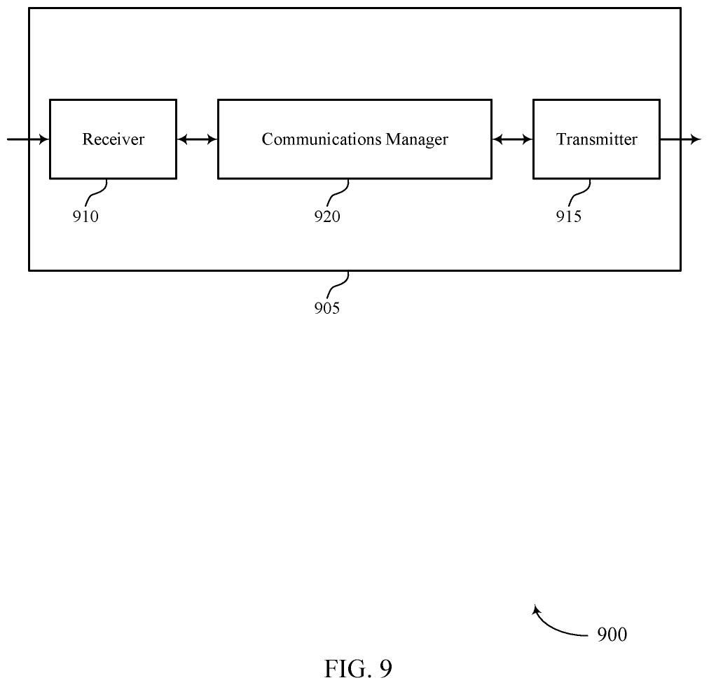

FIG. 9 shows a block diagram 900 of a device 905 that supports SBIC techniques for network energy savings in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of SBIC techniques for network energy savings as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a serving network entity in accordance with examples as disclosed herein. For example, the communications manager 920 may be configured as or otherwise support a means for receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The communications manager 920 may be configured as or otherwise support a means for transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The communications manager 920 may be configured as or otherwise support a means for receiving, from the UE, a measurement report that is based on the first set of measurements and the second set of measurements. The communications manager 920 may be configured as or otherwise support a means for transmitting, to the originating network entity, a SBIC feedback indication for the first subset of frequency bands that is based on the measurement report.

Additionally, or alternatively, the communications manager 920 may support wireless communication at an originating network entity in accordance with examples as disclosed herein. For example, the communications manager 920 may be configured as or otherwise support a means for transmitting, to a serving network entity that serves at least one UE using a first subset of frequency bands from a set of channel frequency bands used for wireless communications, a SBIC feedback request that indicates at least a first subset of frequency bands for interference measurements, and first and second time periods for associated interference measurements. The communications manager 920 may be configured as or otherwise support a means for receiving, from the serving network entity, a SBIC feedback indication for the first subset of frequency bands that is based on measured interference for at least the first subset of frequency bands that is reported to the serving network entity by the at least one UE. The communications manager 920 may be configured as or otherwise support a means for activating a SBIC procedure to adjust a transmission power for communications using at least a second subset of frequency bands based on the SBIC feedback indication.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for SBIC activation based on adjacent sub-band interference measurements, which may reduce network power consumption while providing reliable communications in the network.

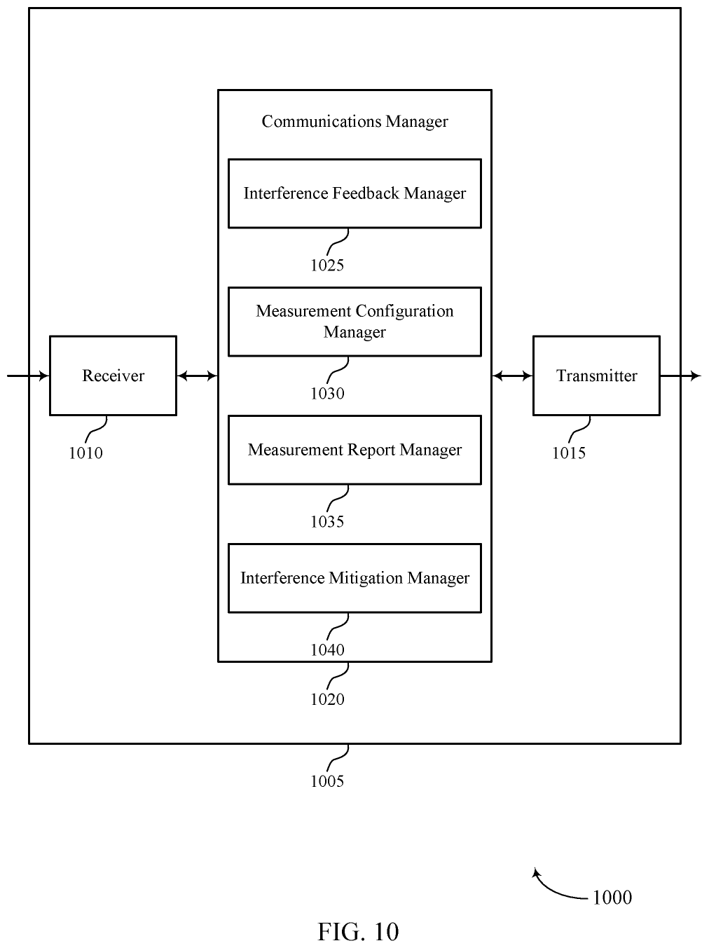

FIG. 10 shows a block diagram 1000 of a device 1005 that supports SBIC techniques for network energy savings in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of SBIC techniques for network energy savings as described herein. For example, the communications manager 1020 may include an interference feedback manager 1025, a measurement configuration manager 1030, a measurement report manager 1035, an interference mitigation manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a serving network entity in accordance with examples as disclosed herein. The interference feedback manager 1025 may be configured as or otherwise support a means for receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The measurement configuration manager 1030 may be configured as or otherwise support a means for transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The measurement report manager 1035 may be configured as or otherwise support a means for receiving, from the UE, a measurement report that is based on the first set of measurements and the second set of measurements. The interference feedback manager 1025 may be configured as or otherwise support a means for transmitting, to the originating network entity, a SBIC feedback indication for the first subset of frequency bands that is based on the measurement report.

Additionally, or alternatively, the communications manager 1020 may support wireless communication at an originating network entity in accordance with examples as disclosed herein. The measurement configuration manager 1030 may be configured as or otherwise support a means for transmitting, to a serving network entity that serves at least one UE using a first subset of frequency bands from a set of channel frequency bands used for wireless communications, a SBIC feedback request that indicates at least a first subset of frequency bands for interference measurements, and first and second time periods for associated interference measurements. The interference feedback manager 1025 may be configured as or otherwise support a means for receiving, from the serving network entity, a SBIC feedback indication for the first subset of frequency bands that is based on measured interference for at least the first subset of frequency bands that is reported to the serving network entity by the at least one UE. The interference mitigation manager 1040 may be configured as or otherwise support a means for activating a SBIC procedure to adjust a transmission power for communications using at least a second subset of frequency bands based on the SBIC feedback indication.

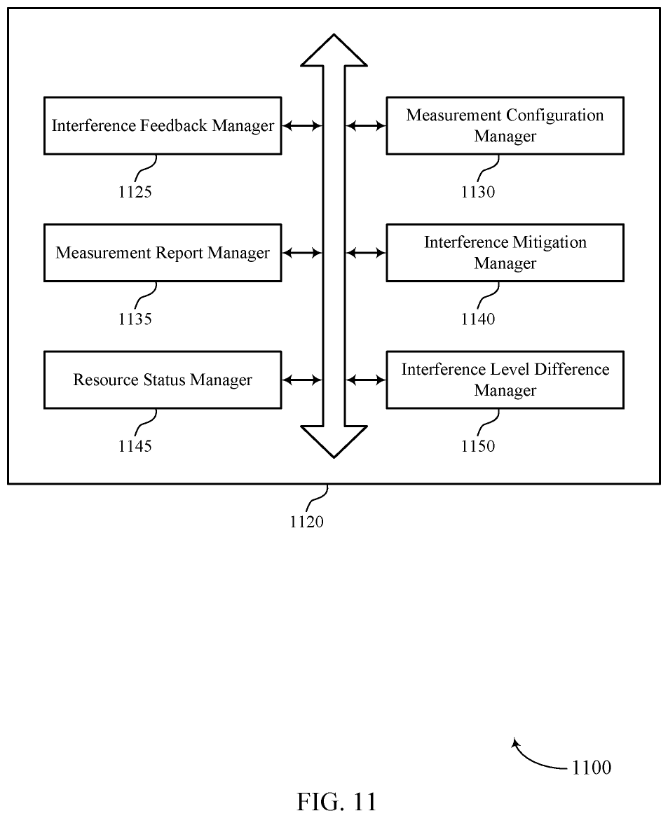

FIG. 11 shows a block diagram 1100 of a communications manager 1120 that supports SBIC techniques for network energy savings in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of SBIC techniques for network energy savings as described herein. For example, the communications manager 1120 may include an interference feedback manager 1125, a measurement configuration manager 1130, a measurement report manager 1135, an interference mitigation manager 1140, a resource status manager 1145, an interference level difference manager 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a serving network entity in accordance with examples as disclosed herein. The interference feedback manager 1125 may be configured as or otherwise support a means for receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The measurement configuration manager 1130 may be configured as or otherwise support a means for transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The measurement report manager 1135 may be configured as or otherwise support a means for receiving, from the UE, a measurement report that is based on the first set of measurements and the second set of measurements. In some examples, the interference feedback manager 1125 may be configured as or otherwise support a means for transmitting, to the originating network entity, a SBIC feedback indication for the first subset of frequency bands that is based on the measurement report.

In some examples, the resource status manager 1145 may be configured as or otherwise support a means for receiving, from the originating network entity, a resource status request for a load associated with downlink resources used for communications with one or more UEs. In some examples, the resource status manager 1145 may be configured as or otherwise support a means for transmitting, to the originating network entity, a resource status response that indicates whether the SBIC feedback request is allowed based on the load associated with the downlink resources used for communications with one or more UEs. In some examples, the first time period corresponds to a first time duration in which the originating network entity refrains from transmissions using the second subset of frequency bands, and the second time period corresponds to a second time duration in which the originating network entity transmits using the second subset of frequency bands. In some examples, the measurement report indicates a difference between a first interference level measured during the first time period and a second interference level measured during the second time period.

In some examples, the measurement report indicates whether a difference between a first interference level measured during the first time period and a second interference level measured during the second time period exceeds a threshold value. In some examples, the SBIC feedback indication provides a difference in measured interference levels between the first time period and the second time period. In some examples, the SBIC feedback request indicates one or more subsets of frequency bands for interference measurements. In some examples, the SBIC feedback indication provides downlink interference levels before and after transmissions of the originating network entity that use SBIC. In some examples, the SBIC feedback indication provides an indication of whether measured interference levels exceed a threshold value when the originating network entity transmits using SBIC only on frequency sub-bands allocated to the originating network entity for communications.

In some examples, the interference feedback manager 1125 may be configured as or otherwise support a means for determining the SBIC feedback indication according to one or more predetermined times for performing a SBIC procedure. In some examples, the interference feedback manager 1125 may be configured as or otherwise support a means for transmitting, to the originating network entity, one or more subsequent SBIC feedback indications for the first subset of frequency bands in accordance with the one or more predetermined times for performing the SBIC procedure.

In some examples, the SBIC feedback indication is based on one or more threshold values associated with one or more of a total physical resource block (PRB) usage of available downlink resources, a control channel element (CCE) usage of available downlink control channel resources, an amount of PRB usage for a synchronization signal block (SSB) area, a CCE usage of available downlink control channel resources for the SSB area, an amount of PRB usage for a network slice radio area, a CCE usage of available downlink control channel resources for the network slice radio area, an amount of PRB usage for multiple-input multiple-output (MIMO) resources, a CCE usage of available downlink control channel resources for the MIMO resources, of any combinations thereof. In some examples, the SBIC feedback indication is based on a mapping table between interference measurements and two or more subsets of frequency bands of the set of channel frequency bands. In some examples, the second subset of frequency bands include only frequency sub-bands on which the originating network entity has allocations for communications with one or more associated UEs.

In some examples, the SBIC feedback request is received via an Xn interface and indicates SBIC activation or deactivation request and an indication of a quantity of downlink transmissions associated with the second time period. In some examples, the interference measurement report indicates a difference in measurements of the first subset of frequency bands between the first time period and the second time period associated with one or more antenna panels associated with the serving network entity.

Additionally, or alternatively, the communications manager 1120 may support wireless communication at an originating network entity in accordance with examples as disclosed herein. In some examples, the measurement configuration manager 1130 may be configured as or otherwise support a means for transmitting, to a serving network entity that serves at least one UE using a first subset of frequency bands from a set of channel frequency bands used for wireless communications, a SBIC feedback request that indicates at least a first subset of frequency bands for interference measurements, and first and second time periods for associated interference measurements. In some examples, the interference feedback manager 1125 may be configured as or otherwise support a means for receiving, from the serving network entity, a SBIC feedback indication for the first subset of frequency bands that is based on measured interference for at least the first subset of frequency bands that is reported to the serving network entity by the at least one UE. The interference mitigation manager 1140 may be configured as or otherwise support a means for activating a SBIC procedure to adjust a transmission power for communications using at least a second subset of frequency bands based on the SBIC feedback indication.

In some examples, the SBIC feedback request includes an indication of one or more allocated downlink sub-bands associated with the second subset of frequency bands. In some examples, the resource status manager 1145 may be configured as or otherwise support a means for transmitting, to the serving network entity, a resource status request for a load associated with downlink resources used for communications with one or more UEs. In some examples, the resource status manager 1145 may be configured as or otherwise support a means for receiving a resource status response that indicates whether the SBIC feedback request is allowed based on the load associated with the downlink resources used for communications with one or more UEs.

In some examples, the SBIC feedback indication provides a difference in measured interference levels between the first time period and the second time period. In some examples, the SBIC feedback request indicates one or more subsets of frequency bands for interference measurements. In some examples, the SBIC feedback indication provides downlink interference levels before and after transmissions that use SBIC. In some examples, the SBIC feedback indication provides an indication of whether measured interference levels exceed a threshold value when the originating network entity transmits using SBIC only on frequency sub-bands allocated to the originating network entity for communications.

In some examples, the measurement configuration manager 1130 may be configured as or otherwise support a means for receiving the SBIC feedback indication according to one or more predetermined times for performing a SBIC procedure. In some examples, the SBIC feedback indication is based on a mapping table between interference measurements and two or more subsets of frequency bands of the set of channel frequency bands.

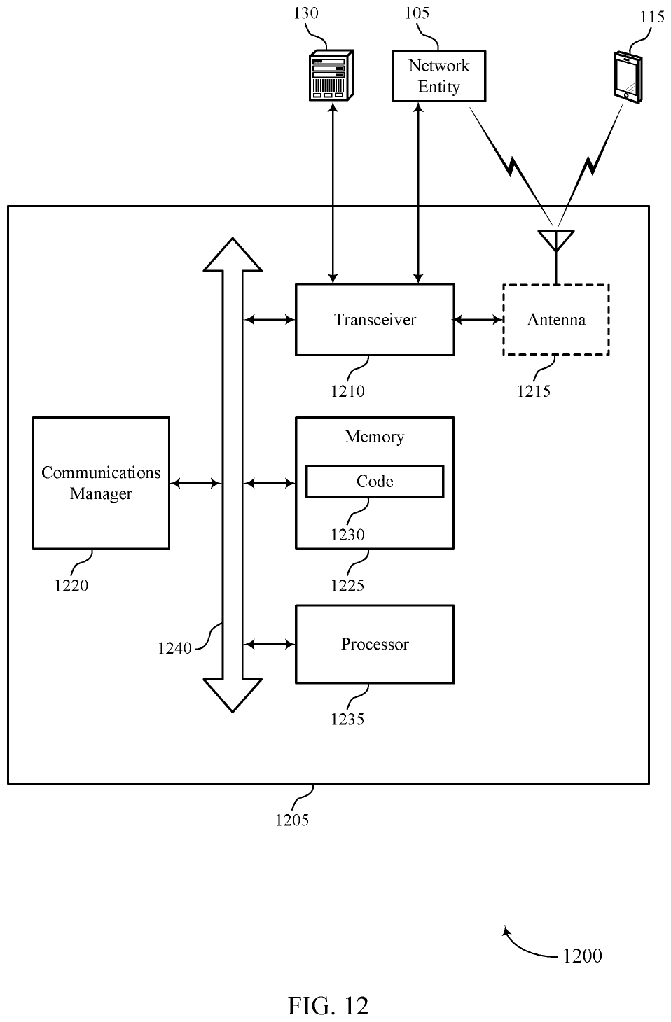

FIG. 12 shows a diagram of a system 1200 including a device 1205 that supports SBIC techniques for network energy savings in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting SBIC techniques for network energy savings). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a serving network entity in accordance with examples as disclosed herein. For example, the communications manager 1220 may be configured as or otherwise support a means for receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The communications manager 1220 may be configured as or otherwise support a means for transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The communications manager 1220 may be configured as or otherwise support a means for receiving, from the UE, a measurement report that is based on the first set of measurements and the second set of measurements. The communications manager 1220 may be configured as or otherwise support a means for transmitting, to the originating network entity, a SBIC feedback indication for the first subset of frequency bands that is based on the measurement report.

Additionally, or alternatively, the communications manager 1220 may support wireless communication at an originating network entity in accordance with examples as disclosed herein. For example, the communications manager 1220 may be configured as or otherwise support a means for transmitting, to a serving network entity that serves at least one UE using a first subset of frequency bands from a set of channel frequency bands used for wireless communications, a SBIC feedback request that indicates at least a first subset of frequency bands for interference measurements, and first and second time periods for associated interference measurements. The communications manager 1220 may be configured as or otherwise support a means for receiving, from the serving network entity, a SBIC feedback indication for the first subset of frequency bands that is based on measured interference for at least the first subset of frequency bands that is reported to the serving network entity by the at least one UE. The communications manager 1220 may be configured as or otherwise support a means for activating a SBIC procedure to adjust a transmission power for communications using at least a second subset of frequency bands based on the SBIC feedback indication.

By including or configuring the communications manager 1220 in accordance with examples as described herein, the device 1205 may support techniques for SBIC activation based on adjacent sub-band interference measurements, which may reduce network power consumption while providing reliable communications in the network.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of SBIC techniques for network energy savings as described herein, or the processor 1235 and the memory 1225 may be otherwise configured to perform or support such operations.

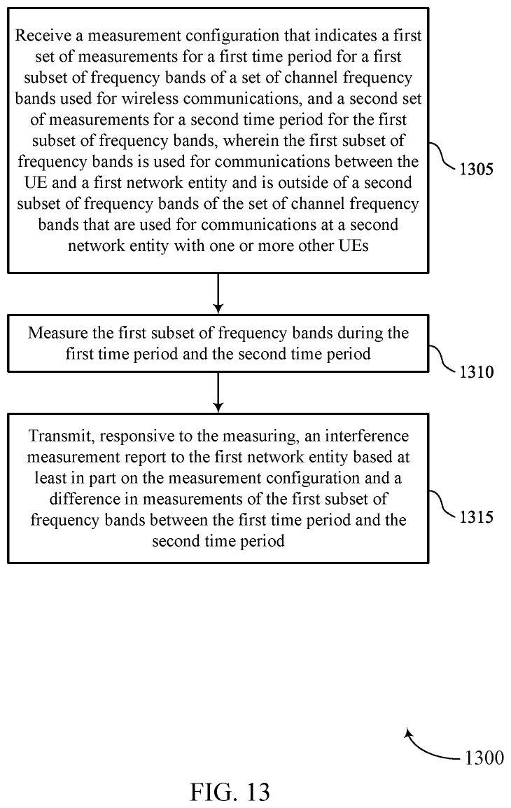

FIG. 13 shows a flowchart illustrating a method 1300 that supports SBIC techniques for network energy savings in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The operations of 1305 may be performed in accordance with examples as disclosed herein. In some examples, aspects of the operations of 1305 may be performed by a configuration manager 725 as described with reference to FIG. 7.

At 1310, the method may include measuring the first subset of frequency bands during the first time period and the second time period. The operations of 1310 may be performed in accordance with examples as disclosed herein. In some examples, aspects of the operations of 1310 may be performed by a measurement manager 730 as described with reference to FIG. 7.

At 1315, the method may include transmitting, responsive to the measuring, an interference measurement report to the first network entity based on the measurement configuration and a difference in measurements of the first subset of frequency bands between the first time period and the second time period. The operations of 1315 may be performed in accordance with examples as disclosed herein. In some examples, aspects of the operations of 1315 may be performed by a measurement report manager 735 as described with reference to FIG. 7.

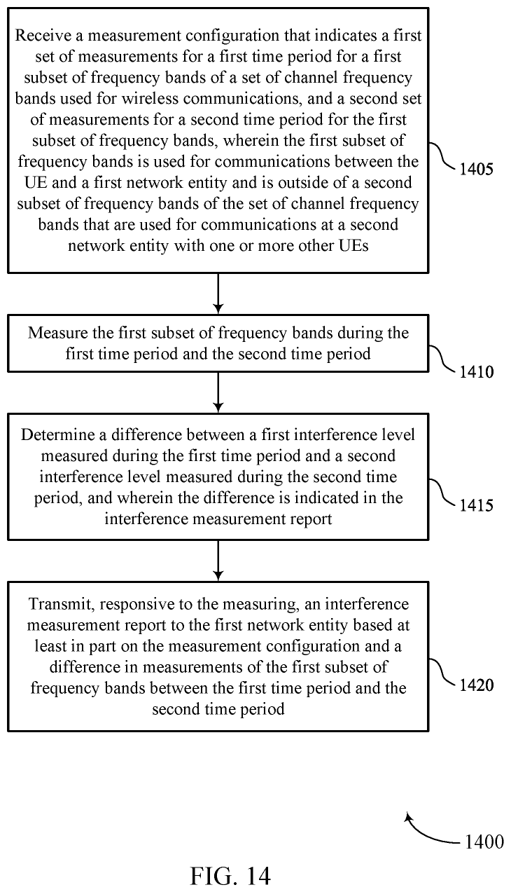

FIG. 14 shows a flowchart illustrating a method 1400 that supports SBIC techniques for network energy savings in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The operations of 1405 may be performed in accordance with examples as disclosed herein. In some examples, aspects of the operations of 1405 may be performed by a configuration manager 725 as described with reference to FIG. 7.

At 1410, the method may include measuring the first subset of frequency bands during the first time period and the second time period. The operations of 1410 may be performed in accordance with examples as disclosed herein. In some examples, aspects of the operations of 1410 may be performed by a measurement manager 730 as described with reference to FIG. 7.

At 1415, the method may include determining a difference between a first interference level measured during the first time period and a second interference level measured during the second time period, and where the difference is indicated in the interference measurement report. The operations of 1415 may be performed in accordance with examples as disclosed herein. In some examples, aspects of the operations of 1415 may be performed by an interference level difference manager 740 as described with reference to FIG. 7.

At 1420, the method may include transmitting, responsive to the measuring, an interference measurement report to the first network entity based on the measurement configuration and a difference in measurements of the first subset of frequency bands between the first time period and the second time period. The operations of 1420 may be performed in accordance with examples as disclosed herein. In some examples, aspects of the operations of 1420 may be performed by a measurement report manager 735 as described with reference to FIG. 7.

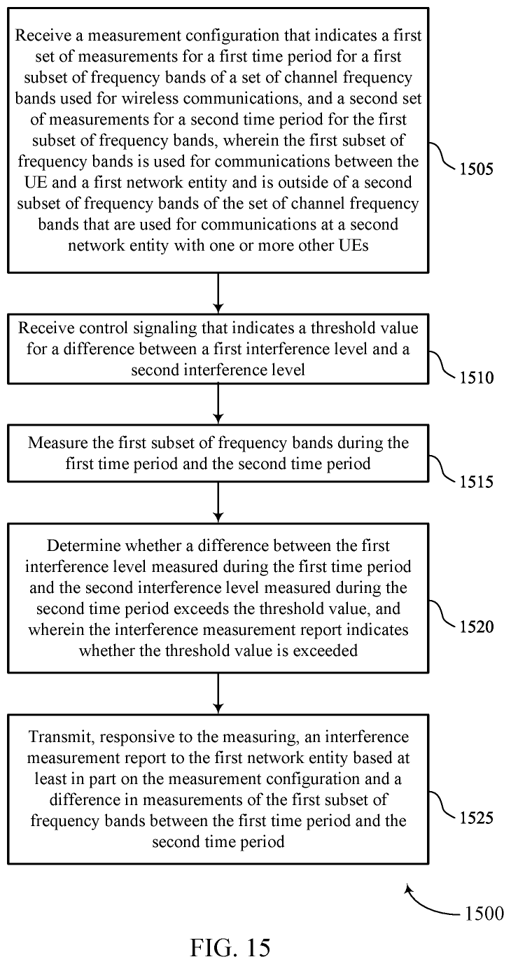

FIG. 15 shows a flowchart illustrating a method 1500 that supports SBIC techniques for network energy savings in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a measurement configuration that indicates a first set of measurements for a first time period for a first subset of frequency bands of a set of channel frequency bands used for wireless communications, and a second set of measurements for a second time period for the first subset of frequency bands, where the first subset of frequency bands is used for communications between the UE and a first network entity and is outside of a second subset of frequency bands of the set of channel frequency bands that are used for communications at a second network entity with one or more other UEs. The operations of 1505 may be performed in accordance with examples as disclosed herein. In some examples, aspects of the operations of 1505 may be performed by a configuration manager 725 as described with reference to FIG. 7.

At 1510, the method may include receiving control signaling that indicates a threshold value for a difference between a first interference level and a second interference level. The operations of 1510 may be performed in accordance with examples as disclosed herein. In some examples, aspects of the operations of 1510 may be performed by an interference level difference manager 740 as described with reference to FIG. 7.

At 1515, the method may include measuring the first subset of frequency bands during the first time period and the second time period. The operations of 1515 may be performed in accordance with examples as disclosed herein. In some examples, aspects of the operations of 1515 may be performed by a measurement manager 730 as described with reference to FIG. 7.

At 1520, the method may include determining whether the difference between a first interference level measured during the first time period and the second interference level measured during the second time period exceeds a threshold value, and where the interference measurement report indicates whether the threshold value is exceeded. The operations of 1520 may be performed in accordance with examples as disclosed herein. In some examples, aspects of the operations of 1520 may be performed by an interference level difference manager 740 as described with reference to FIG. 7.

At 1525, the method may include transmitting, responsive to the measuring, an interference measurement report to the first network entity based on the measurement configuration and a difference in measurements of the first subset of frequency bands between the first time period and the second time period. The operations of 1525 may be performed in accordance with examples as disclosed herein. In some examples, aspects of the operations of 1525 may be performed by a measurement report manager 735 as described with reference to FIG. 7.

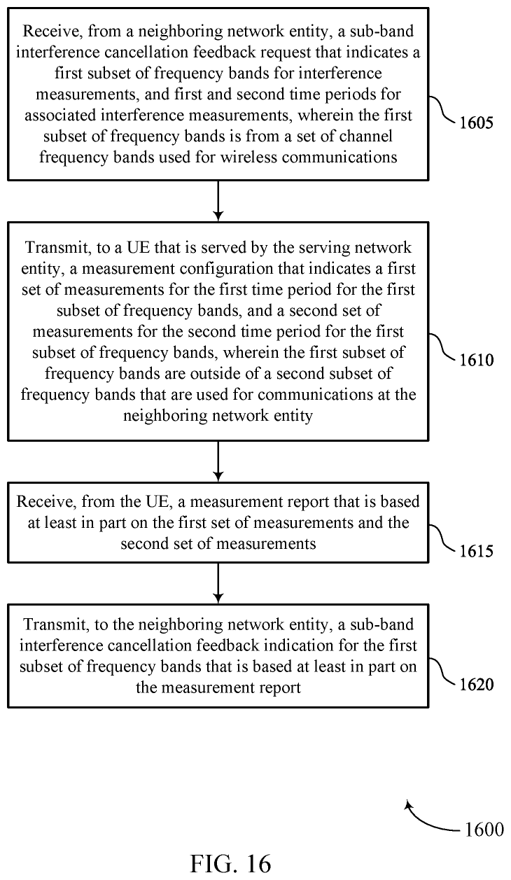

FIG. 16 shows a flowchart illustrating a method 1600 that supports SBIC techniques for network energy savings in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The operations of 1605 may be performed in accordance with examples as disclosed herein. In some examples, aspects of the operations of 1605 may be performed by an interference feedback manager 1125 as described with reference to FIG. 11.

At 1610, the method may include transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The operations of 1610 may be performed in accordance with examples as disclosed herein. In some examples, aspects of the operations of 1610 may be performed by a measurement configuration manager 1130 as described with reference to FIG. 11.

At 1615, the method may include receiving, from the UE, a measurement report that is based on the first set of measurements and the second set of measurements. The operations of 1615 may be performed in accordance with examples as disclosed herein. In some examples, aspects of the operations of 1615 may be performed by a measurement report manager 1135 as described with reference to FIG. 11.

At 1620, the method may include transmitting, to the originating network entity, a SBIC feedback indication for the first subset of frequency bands that is based on the measurement report. The operations of 1620 may be performed in accordance with examples as disclosed herein. In some examples, aspects of the operations of 1620 may be performed by an interference feedback manager 1125 as described with reference to FIG. 11.

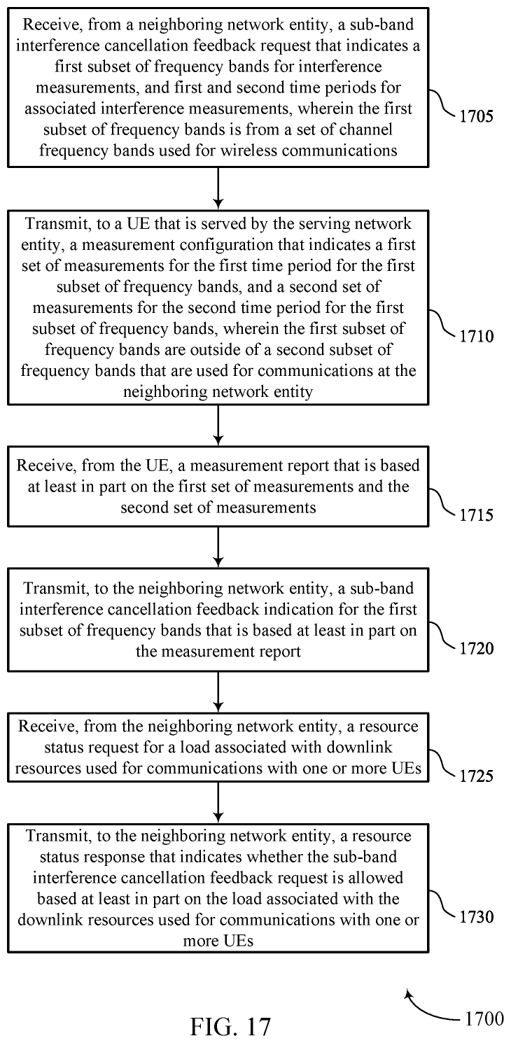

FIG. 17 shows a flowchart illustrating a method 1700 that supports SBIC techniques for network energy savings in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The operations of 1705 may be performed in accordance with examples as disclosed herein. In some examples, aspects of the operations of 1705 may be performed by an interference feedback manager 1125 as described with reference to FIG. 11.

At 1710, the method may include transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The operations of 1710 may be performed in accordance with examples as disclosed herein. In some examples, aspects of the operations of 1710 may be performed by a measurement configuration manager 1130 as described with reference to FIG. 11.

At 1715, the method may include receiving, from the UE, a measurement report that is based on the first set of measurements and the second set of measurements. The operations of 1715 may be performed in accordance with examples as disclosed herein. In some examples, aspects of the operations of 1715 may be performed by a measurement report manager 1135 as described with reference to FIG. 11.

At 1720, the method may include transmitting, to the originating network entity, a SBIC feedback indication for the first subset of frequency bands that is based on the measurement report. The operations of 1720 may be performed in accordance with examples as disclosed herein. In some examples, aspects of the operations of 1720 may be performed by an interference feedback manager 1125 as described with reference to FIG. 11.

At 1725, the method may include receiving, from the originating network entity, a resource status request for a load associated with downlink resources used for communications with one or more UEs. The operations of 1725 may be performed in accordance with examples as disclosed herein. In some examples, aspects of the operations of 1725 may be performed by a resource status manager 1145 as described with reference to FIG. 11.

At 1730, the method may include transmitting, to the originating network entity, a resource status response that indicates whether the SBIC feedback request is allowed based on the load associated with the downlink resources used for communications with one or more UEs. The operations of 1730 may be performed in accordance with examples as disclosed herein. In some examples, aspects of the operations of 1730 may be performed by a resource status manager 1145 as described with reference to FIG. 11.

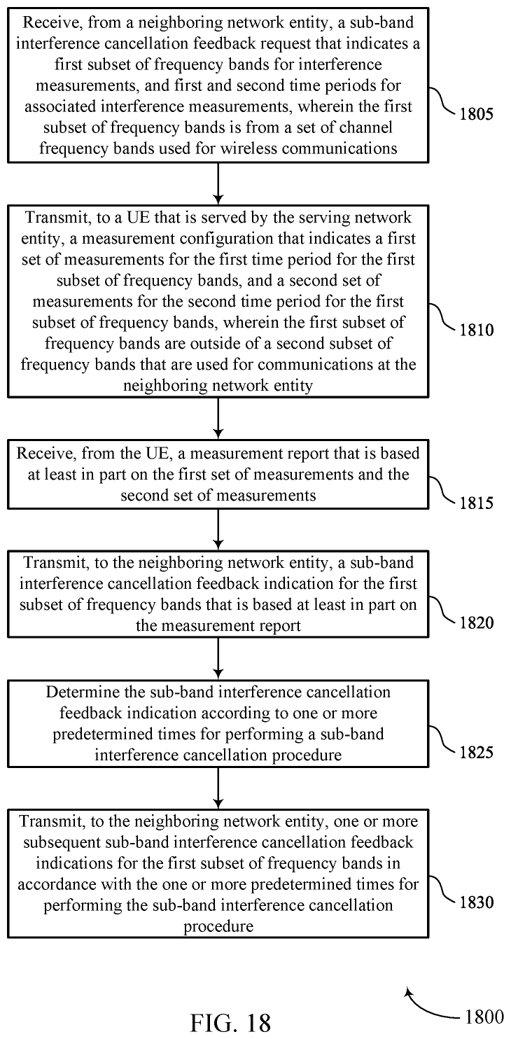

FIG. 18 shows a flowchart illustrating a method 1800 that supports SBIC techniques for network energy savings in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from an originating network entity, a SBIC feedback request that indicates a first subset of frequency bands for interference measurements, and first and second time periods for associated interference measurements, where the first subset of frequency bands is from a set of channel frequency bands used for wireless communications. The operations of 1805 may be performed in accordance with examples as disclosed herein. In some examples, aspects of the operations of 1805 may be performed by an interference feedback manager 1125 as described with reference to FIG. 11.

At 1810, the method may include transmitting, to a UE that is served by the serving network entity, a measurement configuration that indicates a first set of measurements for the first time period for the first subset of frequency bands, and a second set of measurements for the second time period for the first subset of frequency bands, where the first subset of frequency bands are outside of a second subset of frequency bands that are used for communications at the originating network entity. The operations of 1810 may be performed in accordance with examples as disclosed herein. In some examples, aspects of the operations of 1810 may be performed by a measurement configuration manager 1130 as described with reference to FIG. 11.

At 1815, the method may include receiving, from the UE, a measurement report that is based on the first set of measurements and the second set of measurements. The operations of 1815 may be performed in accordance with examples as disclosed herein. In some examples, aspects of the operations of 1815 may be performed by a measurement report manager 1135 as described with reference to FIG. 11.

At 1820, the method may include transmitting, to the originating network entity, a SBIC feedback indication for the first subset of frequency bands that is based on the measurement report. The operations of 1820 may be performed in accordance with examples as disclosed herein. In some examples, aspects of the operations of 1820 may be performed by an interference feedback manager 1125 as described with reference to FIG. 11.

At 1825, the method may include determining the SBIC feedback indication according to one or more predetermined times for performing a SBIC procedure. The operations of 1825 may be performed in accordance with examples as disclosed herein. In some examples, aspects of the operations of 1825 may be performed by an interference feedback manager 1125 as described with reference to FIG. 11.

At 1830, the method may include transmitting, to the originating network entity, one or more subsequent SBIC feedback indications for the first subset of frequency bands in accordance with the one or more predetermined times for performing the SBIC procedure. The operations of 1830 may be performed in accordance with examples as disclosed herein. In some examples, aspects of the operations of 1830 may be performed by an interference feedback manager 1125 as described with reference to FIG. 11.

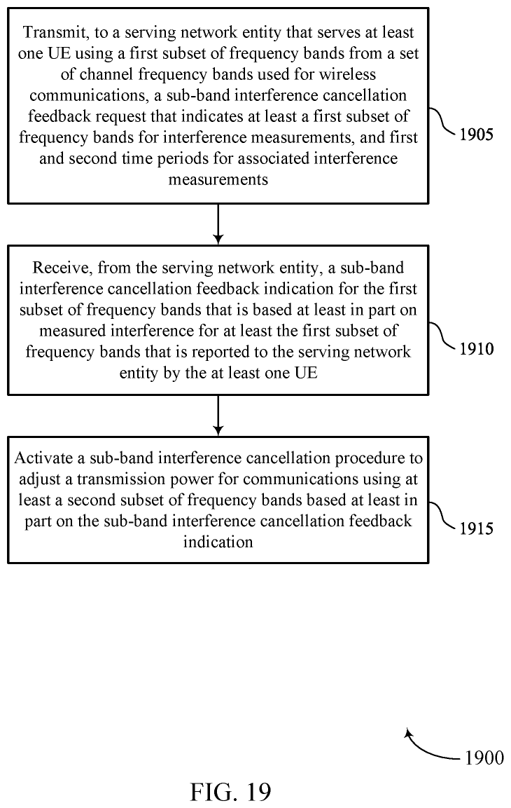

FIG. 19 shows a flowchart illustrating a method 1900 that supports SBIC techniques for network energy savings in accordance with one or more aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a serving network entity that serves at least one UE using a first subset of frequency bands from a set of channel frequency bands used for wireless communications, a SBIC feedback request that indicates at least a first subset of frequency bands for interference measurements, and first and second time periods for associated interference measurements. The operations of 1905 may be performed in accordance with examples as disclosed herein. In some examples, aspects of the operations of 1905 may be performed by a measurement configuration manager 1130 as described with reference to FIG. 11.

At 1910, the method may include receiving, from the serving network entity, a SBIC feedback indication for the first subset of frequency bands that is based on measured interference for at least the first subset of frequency bands that is reported to the serving network entity by the at least one UE. The operations of 1910 may be performed in accordance with examples as disclosed herein. In some examples, aspects of the operations of 1910 may be performed by an interference feedback manager 1125 as described with reference to FIG. 11.

At 1915, the method may include activating a SBIC procedure to adjust a transmission power for communications using at least a second subset of frequency bands based on the SBIC feedback indication. The operations of 1915 may be performed in accordance with examples as disclosed herein. In some examples, aspects of the operations of 1915 may be performed by an interference mitigation manager 1140 as described with reference to FIG. 11.

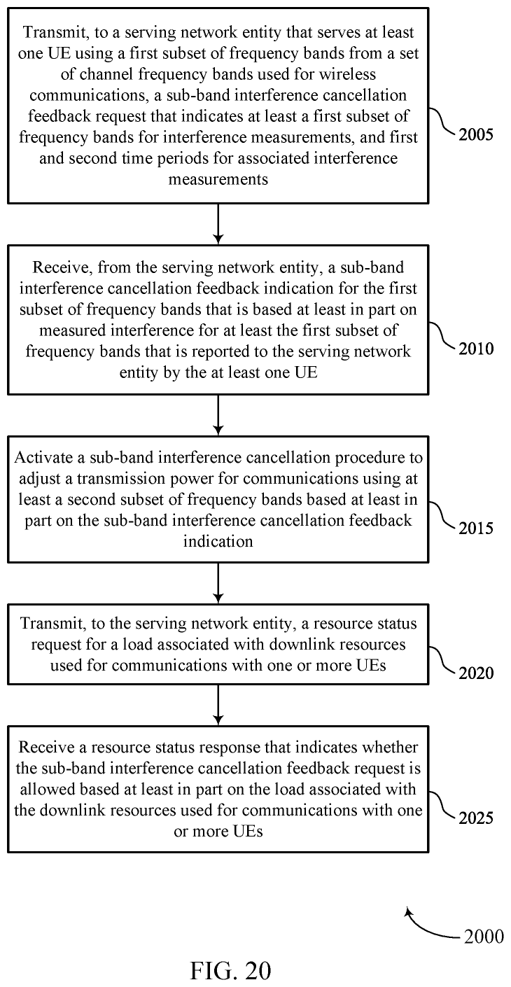

FIG. 20 shows a flowchart illustrating a method 2000 that supports SBIC techniques for network energy savings in accordance with one or more aspects of the present disclosure. The operations of the method 2000 may be implemented by a network entity or its components as described herein. For example, the operations of the method 2000 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a serving network entity that serves at least one UE using a first subset of frequency bands from a set of channel frequency bands used for wireless communications, a SBIC feedback request that indicates at least a first subset of frequency bands for interference measurements, and first and second time periods for associated interference measurements. The operations of 2005 may be performed in accordance with examples as disclosed herein. In some examples, aspects of the operations of 2005 may be performed by a measurement configuration manager 1130 as described with reference to FIG. 11.

At 2010, the method may include receiving, from the serving network entity, a SBIC feedback indication for the first subset of frequency bands that is based on measured interference for at least the first subset of frequency bands that is reported to the serving network entity by the at least one UE. The operations of 2010 may be performed in accordance with examples as disclosed herein. In some examples, aspects of the operations of 2010 may be performed by an interference feedback manager 1125 as described with reference to FIG. 11.

At 2015, the method may include activating a SBIC procedure to adjust a transmission power for communications using at least a second subset of frequency bands based on the SBIC feedback indication. The operations of 2015 may be performed in accordance with examples as disclosed herein. In some examples, aspects of the operations of 2015 may be performed by an interference mitigation manager 1140 as described with reference to FIG. 11.

At 2020, the method may include transmitting, to the serving network entity, a resource status request for a load associated with downlink resources used for communications with one or more UEs. The operations of 2020 may be performed in accordance with examples as disclosed herein. In some examples, aspects of the operations of 2020 may be performed by a resource status manager 1145 as described with reference to FIG. 11.

At 2025, the method may include receiving a resource status response that indicates whether the SBIC feedback request is allowed based on the load associated with the downlink resources used for communications with one or more UEs. The operations of 2025 may be performed in accordance with examples as disclosed herein. In some examples, aspects of the operations of 2025 may be performed by a resource status manager 1145 as described with reference to FIG. 11.

The following provides an overview of aspects of the present disclosure:
Aspect 1: A method for wireless communication at a UE, comprising: receiving a measurement configuration that indicates a first set of measurements for a first time period for a first subset of frequency bands of a set of channel frequency bands used for wireless communications, and a second set of measurements for a second time period for the first subset of frequency bands, wherein the first subset of frequency bands is used for communications between the UE and a first network entity and is outside of a second subset of frequency bands of the set of channel frequency bands that are used for communications at a second network entity with one or more other UEs; measuring the first subset of frequency bands during the first time period and the second time period; and transmitting, responsive to the measuring, an interference measurement report to the first network entity based at least in part on the measurement configuration and a difference in measurements of the first subset of frequency bands between the first time period and the second time period.
Aspect 2: The method of aspect 1, wherein the first time period corresponds to a first time duration in which the one or more other network entities refrain from transmissions using the second subset of frequency bands, and the second time period corresponds to a second time duration in which the one or more other network entities transmits using the second subset of frequency bands.
Aspect 3: The method of any of aspects 1 through 2, wherein the measuring further comprises: determining a difference between a first interference level measured during the first time period and a second interference level measured during the second time period, and wherein the difference is indicated in the interference measurement report.
Aspect 4: The method of any of aspects 1 through 2, wherein the measuring further comprises: determining whether a difference between a first interference level measured during the first time period and a second interference level measured during the second time period exceeds a threshold value, and wherein the interference measurement report indicates whether the threshold value is exceeded.
Aspect 5: The method of aspect 4, further comprising: receiving control signaling that indicates the threshold value.
Aspect 6: The method of any of aspects 1 through 5, wherein the measurement configuration includes one or more sub-band indices that indicate the first subset of frequency bands to be measured during the first time period and the second time period.
Aspect 7: The method of any of aspects 1 through 6, wherein the interference measurement report indicates a difference in measurements of the first subset of frequency bands between the first time period and the second time period associated with one or more antenna panels associated with the first network entity.
Aspect 8: The method of any of aspects 1 through 7, further comprising: measuring at least a third subset of frequency bands during the first time period and the second time period, wherein the third subset of frequency bands are adjacent in frequency to the first subset of frequency bands or the second subset of frequency bands.
Aspect 9: A method for wireless communication at a serving network entity, comprising: receiving, from a neighboring network entity, a sub-band interference cancellation feedback request that indicates a first subset of frequency bands for interference measurements, and first and second time periods for associated interference measurements, wherein the first subset of frequency bands is from a set of channel frequency bands used for wireless communications; transmitting, to a UE that is served by the serving network entity, a measurement configuration that indicates a first set of measurements for the first time period for the first subset of frequency bands, and a second set of measurements for the second time period for the first subset of frequency bands, wherein the first subset of frequency bands are outside of a second subset of frequency bands that are used for communications at the neighboring network entity; receiving, from the UE, a measurement report that is based at least in part on the first set of measurements and the second set of measurements; and transmitting, to the neighboring network entity, a sub-band interference cancellation feedback indication for the first subset of frequency bands that is based at least in part on the measurement report.
Aspect 10: The method of aspect 9, further comprising: receiving, from the neighboring network entity, a resource status request for a load associated with downlink resources used for communications with one or more UEs; and transmitting, to the neighboring network entity, a resource status response that indicates whether the sub-band interference cancellation feedback request is allowed based at least in part on the load associated with the downlink resources used for communications with one or more UEs.
Aspect 11: The method of any of aspects 9 through 10, wherein the first time period corresponds to a first time duration in which the neighboring network entity refrains from transmissions using the second subset of frequency bands, and the second time period corresponds to a second time duration in which the neighboring network entity transmits using the second subset of frequency bands.
Aspect 12: The method of any of aspects 9 through 10, wherein the first time period corresponds to a first time duration in which the originating network entity transmits using the second subset of frequency bands based on a first interference cancellation procedure that is applied to the set of channel frequency bands, and the second time period corresponds to a second time duration in which the originating network entity transmits using the second subset of frequency bands based on a second interference cancellation procedure that is applied only to the second subset of frequency bands.
Aspect 13: The method of any of aspects 9 through 12, wherein the measurement report indicates a difference between a first interference level measured during the first time period and a second interference level measured during the second time period.
Aspect 14: The method of any of aspects 9 through 13, wherein the measurement report indicates whether a difference between a first interference level measured during the first time period and a second interference level measured during the second time period exceeds a threshold value.
Aspect 15: The method of any of aspects 9 through 12, wherein the sub-band interference cancellation feedback indication provides a difference in measured interference levels between the first time period and the second time period.
Aspect 16: The method of any of aspects 9 through 15, wherein the sub-band interference cancellation feedback request indicates one or more subsets of frequency bands for interference measurements.
Aspect 17: The method of any of aspects 9 through 16, wherein the sub-band interference cancellation feedback indication provides downlink interference levels before and after transmissions of the neighboring network entity that use sub-band interference cancellation.
Aspect 18: The method of any of aspects 9 through 17, wherein the sub-band interference cancellation feedback indication provides an indication of whether measured interference levels exceed a threshold value when the neighboring network entity transmits using sub-band interference cancellation only on frequency sub-bands allocated to the neighboring network entity for communications.
Aspect 19: The method of any of aspects 9 through 18, further comprising: determining the sub-band interference cancellation feedback indication according to one or more predetermined times for performing a sub-band interference cancellation procedure; and transmitting, to the neighboring network entity, one or more subsequent sub-band interference cancellation feedback indications for the first subset of frequency bands in accordance with the one or more predetermined times for performing the sub-band interference cancellation procedure.
Aspect 20: The method of any of aspects 9 through 19, wherein the sub-band interference cancellation feedback indication is based at least in part on one or more threshold values associated with one or more of a total physical resource block (PRB) usage of available downlink resources, a control channel element (CCE) usage of available downlink control channel resources, an amount of PRB usage for a synchronization signal block (SSB) area, a CCE usage of available downlink control channel resources for the SSB area, an amount of PRB usage for a network slice radio area, a CCE usage of available downlink control channel resources for the network slice radio area, an amount of PRB usage for multiple-input multiple-output (MIMO) resources, a CCE usage of available downlink control channel resources for the MIMO resources, of any combinations thereof.
Aspect 21: The method of any of aspects 9 through 20, wherein the sub-band interference cancellation feedback indication is based at least in part on a mapping table between interference measurements and two or more subsets of frequency bands of the set of channel frequency bands.
Aspect 22: The method of any of aspects 9 through 21, wherein the second subset of frequency bands include only frequency sub-bands on which the neighboring network entity has allocations for communications with one or more associated UEs.
Aspect 23: The method of any of aspects 9 through 22, wherein the sub-band interference cancellation feedback request is received via an Xn interface and indicates sub-band interference cancellation activation or deactivation request and an indication of a quantity of downlink transmissions associated with the second time period.
Aspect 24: The method of any of aspects 9 through 23, wherein the interference measurement report indicates a difference in measurements of the first subset of frequency bands between the first time period and the second time period associated with one or more antenna panels associated with the serving network entity.
Aspect 25: A method for wireless communication at a neighboring network entity, comprising: transmitting, to a serving network entity that serves at least one UE using a first subset of frequency bands from a set of channel frequency bands used for wireless communications, a sub-band interference cancellation feedback request that indicates at least a first subset of frequency bands for interference measurements, and first and second time periods for associated interference measurements; receiving, from the serving network entity, a sub-band interference cancellation feedback indication for the first subset of frequency bands that is based at least in part on measured interference for at least the first subset of frequency bands that is reported to the serving network entity by the at least one UE; and activating a sub-band interference cancellation procedure to adjust a transmission power for communications using at least a second subset of frequency bands based at least in part on the sub-band interference cancellation feedback indication.
Aspect 26: The method of aspect 25, wherein the sub-band interference cancellation feedback request includes an indication of one or more allocated downlink sub-bands associated with the second subset of frequency bands.
Aspect 27: The method of any of aspects 25 through 26, further comprising: transmitting, to the serving network entity, a resource status request for a load associated with downlink resources used for communications with one or more UEs; and receiving a resource status response that indicates whether the sub-band interference cancellation feedback request is allowed based at least in part on the load associated with the downlink resources used for communications with one or more UEs.
Aspect 28: The method of any of aspects 25 through 27, wherein the sub-band interference cancellation feedback indication provides a difference in measured interference levels between the first time period and the second time period.
Aspect 29: The method of any of aspects 25 through 28, wherein the sub-band interference cancellation feedback request indicates one or more subsets of frequency bands for interference measurements.
Aspect 30: The method of any of aspects 25 through 27, wherein the sub-band interference cancellation feedback indication provides downlink interference levels before and after transmissions that use sub-band interference cancellation.
Aspect 31: The method of any of aspects 25 through 27, wherein the sub-band interference cancellation feedback indication provides an indication of whether measured interference levels exceed a threshold value when the neighboring network entity transmits using sub-band interference cancellation only on frequency sub-bands allocated to the neighboring network entity for communications.
Aspect 32: The method of any of aspects 25 through 31, further comprising: receiving the sub-band interference cancellation feedback indication according to one or more predetermined times for performing a sub-band interference cancellation procedure.
Aspect 33: The method of any of aspects 25 through 32, wherein the sub-band interference cancellation feedback indication is based at least in part on a mapping table between interference measurements and two or more subsets of frequency bands of the set of channel frequency bands.
Aspect 34: A UE for wireless communication, comprising one or more memories storing processor-executable code; and one or more processors coupled with the one or more memories and individually or collectively operable to execute the code to cause the UE to perform a method of any of aspects 1 through 8.
Aspect 35: An UE for wireless communication, comprising at least one means for performing a method of any of aspects 1 through 8.
Aspect 36: A non-transitory computer-readable medium storing code for wireless communication at a UE, the code comprising instructions executable by one or more processors to perform a method of any of aspects 1 through 8.
Aspect 37: A serving network entity for wireless communication, comprising one or more memories storing processor-executable code; and one or more processors coupled with the one or more memories and individually or collectively operable to execute the code to cause the serving network entity to perform a method of any of aspects 9 through 24.
Aspect 38: A serving network entity for wireless communication, comprising at least one means for performing a method of any of aspects 9 through 24.
Aspect 39: A non-transitory computer-readable medium storing code for wireless communication at a serving network entity, the code comprising instructions executable by one or more processors to perform a method of any of aspects 9 through 24.
Aspect 40: A neighboring network entity for wireless communication, comprising one or more memories storing processor-executable code; and one or more processors coupled with the one or more memories and individually or collectively operable to execute the code to cause the neighboring network entity to perform a method of any of aspects 25 through 33.
Aspect 41: A neighboring network entity for wireless communication, comprising at least one means for performing a method of any of aspects 25 through 33.
Aspect 42: A non-transitory computer-readable medium storing code for wireless communication at a neighboring network entity, the code comprising instructions executable by one or more processors to perform a method of any of aspects 25 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a measurement configuration that indicates a first set of measurements for a first time period for a first subset of frequency bands of a set of channel frequency bands used for wireless communications, and a second set of measurements for a second time period for the first subset of frequency bands, wherein the first subset of frequency bands is used for communications between the UE and a first network entity and is outside of a second subset of frequency bands of the set of channel frequency bands that are used for communications at a second network entity with one or more other UEs;
measuring the first subset of frequency bands during the first time period and the second time period; and
transmitting, responsive to the measuring, an interference measurement report to the first network entity based at least in part on the measurement configuration and a difference in measurements of the first subset of frequency bands between the first time period and the second time period.

2. The method of claim 1, wherein the first time period corresponds to a first time duration in which the one or more other network entities refrain from transmissions using the second subset of frequency bands, and the second time period corresponds to a second time duration in which the one or more other network entities transmits using the second subset of frequency bands.

3. The method of claim 1, wherein the measuring further comprises:
determining a difference between a first interference level measured during the first time period and a second interference level measured during the second time period, and wherein the difference is indicated in the interference measurement report.

4. The method of claim 1, wherein the measuring further comprises:
determining whether a difference between a first interference level measured during the first time period and a second interference level measured during the second time period exceeds a threshold value, and wherein the interference measurement report indicates whether the threshold value is exceeded.

5. The method of claim 4, further comprising:
receiving control signaling that indicates the threshold value.

6. The method of claim 1, wherein the measurement configuration includes one or more sub-band indices that indicate the first subset of frequency bands to be measured during the first time period and the second time period.

7. The method of claim 1, wherein the interference measurement report indicates a difference in measurements of the first subset of frequency bands between the first time period and the second time period associated with one or more antenna panels associated with the first network entity.

8. The method of claim 1, further comprising:
measuring at least a third subset of frequency bands during the first time period and the second time period, wherein the third subset of frequency bands are adjacent in frequency to the first subset of frequency bands or the second subset of frequency bands.

9. A method for wireless communication at a serving network entity, comprising:
receiving, from an originating network entity, a sub-band interference cancellation feedback request that indicates a first subset of frequency bands for interference measurements, and first and second time periods for associated interference measurements, wherein the first subset of frequency bands is from a set of channel frequency bands used for wireless communications;
transmitting, to a user equipment (UE) that is served by the serving network entity, a measurement configuration that indicates a first set of measurements for the first time period for the first subset of frequency bands, and a second set of measurements for the second time period for the first subset of frequency bands, wherein the first subset of frequency bands are outside of a second subset of frequency bands that are used for communications at the originating network entity;
receiving, from the UE, a measurement report that is based at least in part on the first set of measurements and the second set of measurements; and
transmitting, to the originating network entity, a sub-band interference cancellation feedback indication for the first subset of frequency bands that is based at least in part on the measurement report.

10. The method of claim 9, further comprising:
receiving, from the originating network entity, a resource status request for a load associated with downlink resources used for communications with one or more UEs; and
transmitting, to the originating network entity, a resource status response that indicates whether the sub-band interference cancellation feedback request is allowed based at least in part on the load associated with the downlink resources used for communications with one or more UEs.

11. The method of claim 9, wherein the first time period corresponds to a first time duration in which the originating network entity refrains from transmissions using the second subset of frequency bands, and the second time period corresponds to a second time duration in which the originating network entity transmits using the second subset of frequency bands.

12. The method of claim 9, wherein the first time period corresponds to a first time duration in which the originating network entity transmits using the second subset of frequency bands based on a first interference cancellation procedure that is applied to the set of channel frequency bands, and the second time period corresponds to a second time duration in which the originating network entity transmits using the second subset of frequency bands based on a second interference cancellation procedure that is applied only to the second subset of frequency bands.

13. The method of claim 9, wherein the measurement report indicates one or more of a difference between a first interference level measured during the first time period and a second interference level measured during the second time period, or whether the difference between the first interference level and the second interference level exceeds a threshold value.

14. The method of claim 9, wherein the sub-band interference cancellation feedback indication provides one or more of:
a difference in measured interference levels between the first time period and the second time period;
downlink interference levels before and after transmissions of the originating network entity that use sub-band interference cancellation; or
an indication of whether measured interference levels exceed a threshold value when the originating network entity transmits using sub-band interference cancellation only on frequency sub-bands allocated to the originating network entity for communications.

15. The method of claim 9, wherein the sub-band interference cancellation feedback request indicates one or more subsets of frequency bands for interference measurements.

16. The method of claim 9, further comprising:
determining the sub-band interference cancellation feedback indication according to one or more predetermined times for performing a sub-band interference cancellation procedure; and
transmitting, to the originating network entity, one or more subsequent sub-band interference cancellation feedback indications for the first subset of frequency bands in accordance with the one or more predetermined times for performing the sub-band interference cancellation procedure.

17. The method of claim 9, wherein the sub-band interference cancellation feedback indication is based at least in part on one or more threshold values associated with one or more of a total physical resource block (PRB) usage of available downlink resources, a control channel element (CCE) usage of available downlink control channel resources, an amount of PRB usage for a synchronization signal block (SSB) area, a CCE usage of available downlink control channel resources for the SSB area, an amount of PRB usage for a network slice radio area, a CCE usage of available downlink control channel resources for the network slice radio area, an amount of PRB usage for multiple-input multiple-output (MIMO) resources, a CCE usage of available downlink control channel resources for the MIMO resources, of any combinations thereof.

18. The method of claim 9, wherein the sub-band interference cancellation feedback indication is based at least in part on a mapping table between interference measurements and two or more subsets of frequency bands of the set of channel frequency bands.

19. The method of claim 9, wherein the second subset of frequency bands include only frequency sub-bands on which the originating network entity has allocations for communications with one or more associated UEs.

20. The method of claim 9, wherein the sub-band interference cancellation feedback request is received via an Xn interface and indicates sub-band interference cancellation activation or deactivation request and an indication of a quantity of downlink transmissions associated with the second time period.

21. The method of claim 9, wherein the interference measurement report indicates a difference in measurements of the first subset of frequency bands between the first time period and the second time period associated with one or more antenna panels associated with the serving network entity.

22. A method for wireless communication at an originating network entity, comprising:
transmitting, to a serving network entity that serves at least one user equipment (UE) using a first subset of frequency bands from a set of channel frequency bands used for wireless communications, a sub-band interference cancellation feedback request that indicates at least a first subset of frequency bands for interference measurements, and first and second time periods for associated interference measurements;
receiving, from the serving network entity, a sub-band interference cancellation feedback indication for the first subset of frequency bands that is based at least in part on measured interference for at least the first subset of frequency bands that is reported to the serving network entity by the at least one UE; and
activating a sub-band interference cancellation procedure to adjust a transmission power for communications using at least a second subset of frequency bands based at least in part on the sub-band interference cancellation feedback indication.

23. The method of claim 22, wherein the sub-band interference cancellation feedback request includes one or more of:
an indication of one or more allocated downlink sub-bands associated with the second subset of frequency bands;
a difference in measured interference levels between the first time period and the second time period; or
one or more subsets of frequency bands for interference measurements.

24. The method of claim 22, further comprising:
transmitting, to the serving network entity, a resource status request for a load associated with downlink resources used for communications with one or more UEs; and
receiving a resource status response that indicates whether the sub-band interference cancellation feedback request is allowed based at least in part on the load associated with the downlink resources used for communications with one or more UEs.

25. The method of claim 22, wherein the sub-band interference cancellation feedback indication provides one or more of:
downlink interference levels before and after transmissions that use sub-band interference cancellation; or
an indication of whether measured interference levels exceed a threshold value when the originating network entity transmits using sub-band interference cancellation only on frequency sub-bands allocated to the originating network entity for communications.

26. The method of claim 22, further comprising:
receiving the sub-band interference cancellation feedback indication according to one or more predetermined times for performing a sub-band interference cancellation procedure.

27. The method of claim 22, wherein the sub-band interference cancellation feedback indication is based at least in part on a mapping table between interference measurements and two or more subsets of frequency bands of the set of channel frequency bands.

28. A user equipment (UE) for wireless communication, comprising:
one or more memories storing processor-executable code; and
one or more processors couples with the one or more memories and individually or collectively operable to execute the code to cause the UE to:
receive a measurement configuration that indicates a first set of measurements for a first time period for a first subset of frequency bands of a set of channel frequency bands used for wireless communications, and a second set of measurements for a second time period for the first subset of frequency bands, wherein the first subset of frequency bands is used for communications between the UE and a first network entity and is outside of a second subset of frequency bands of the set of channel frequency bands that are used for communications at a second network entity with one or more other UEs;
measure the first subset of frequency bands during the first time period and the second time period; and
transmit, responsive to the measuring, an interference measurement report to the first network entity based at least in part on the measurement configuration and a difference in measurements of the first subset of frequency bands between the first time period and the second time period.

29. The UE of claim 28, wherein the first time period corresponds to a first time duration in which the one or more other network entities refrain from transmissions using the second subset of frequency bands, and the second time period corresponds to a second time duration in which the one or more other network entities transmits using the second subset of frequency bands.

30. The UE of claim 28, wherein the one or more processors are individually or collectively further operable to execute the code to cause the UE to:
determine a difference between a first interference level measured during the first time period and a second interference level measured during the second time period, and wherein the difference is indicated in the interference measurement report.
